(19) United States
(12) Patent Application Publication
(10) Pub. No.: US 2025/0343355 A1
(43) Pub. Date: Nov. 6, 2025

(54) LOW-FREQUENCY ANTENNA ELEMENT, HIGH-FREQUENCY ANTENNA ELEMENT, ANTENNA ARRAY, AND TERMINAL DEVICE

(71) Applicant: HUAWEI TECHNOLOGIES CO., LTD., Shenzhen (CN)

(72) Inventors: Shuyi Lin, Dongguan (CN); Junhong Zhang, Dongguan (CN); Song Wu, Wuhan (CN)

(73) Assignee: HUAWEI TECHNOLOGIES CO., LTD., Shenzhen (CN)

(21) Appl. No.: 19/272,503

(22) Filed: Jul. 17, 2025

Related U.S. Application Data
(63) Continuation of application No. PCT/CN2024/070497, filed on Jan. 4, 2024.

(30) Foreign Application Priority Data
Jan. 20, 2023 (CN) 202310087492.1

(51) Int. Cl. H01Q 9/04; H01Q 5/42

(52) U.S. Cl. CPC H01Q 9/0414; H01Q 5/42

(57) ABSTRACT

A low-frequency antenna element, a high-frequency antenna element, and a terminal device are disclosed. The terminal device comprises at least one of the low-frequency antenna element or the high-frequency antenna element, the low-frequency antenna element and the high-frequency antenna element are alternately disposed at an interval.

### CROSS-REFERENCE TO RELATED APPLICATIONS

This application is a continuation of International Application No. PCT/CN2024/070497, filed on Jan. 4, 2024, which claims priority to Chinese Patent Application No. 202310087492.1, filed on Jan. 20, 2023. The disclosures of the aforementioned applications are hereby incorporated by reference in their entireties.

### TECHNICAL FIELD

Embodiments of this application relate to the field of communication technologies, and in particular, to a low-frequency antenna element, a high-frequency antenna element, an antenna array, and a terminal device.

### BACKGROUND

As terminal devices continue to shrink in size, antennas, serving as radiating devices at a radio frequency front-end, has increasingly limited available space. Therefore, when inter-frequency antennas coexist, there is an increasingly short distance between the inter-frequency antennas due to increasingly limited available space of the antennas. Consequently, mutual interference is generated between the inter-frequency antennas, resulting in deterioration of performance of the antennas, causing an inter-frequency blocking problem in a radio frequency system, and affecting communication quality.

In a related technology, a cascaded filter is usually used, that is, antennas at different frequencies are separately connected to the filter, and interference caused by mutual coupling between the inter-frequency antennas is reduced by using an out-of-band suppression characteristic of the filter. However, use of the cascaded filter results in an increase in costs of a radio frequency link and an increase in a volume of the antenna for a wavelength corresponding to a center frequency in a suppressed frequency band. This is inconducive to miniaturization development of the antenna and the terminal device.

### SUMMARY

Embodiments of this application provide a low-frequency antenna element, a high-frequency antenna element, an antenna array, and a terminal device. Both the low-frequency antenna element and the high-frequency antenna element can suppress an inter-frequency signal, and have a simple structure, a small volume, and low costs.

According to a first aspect, an embodiment of this application provides a low-frequency antenna element, including a metal layer and a substrate. The metal layer is located on a surface of the substrate, and the metal layer includes a ground plane, a radiator, and a short-circuit transmission line. A first slot is disposed between the ground plane and the radiator. The first slot extends in a first direction, and the ground plane and the radiator are respectively on two sides of the first slot in a second direction. The first direction is perpendicular to the second direction. A feed component is disposed in the first slot. The radiator is connected to a positive electrode of the feed component, and a positive electrode of the low-frequency antenna element is located on the radiator. The ground plane is connected to a negative electrode of the feed component, and a negative electrode of the low-frequency antenna element is located on the ground plane. One end of the short-circuit transmission line is connected to the positive electrode of the low-frequency antenna element, and the other end is connected to the negative electrode of the low-frequency antenna element. At least a partial structure of the short-circuit transmission line is located on the ground plane or the radiator. The second direction is an extension direction of the metal layer.

The first slot is disposed at the metal layer, so that the metal layer is divided into two parts. One part may be used as the radiator of the low-frequency antenna element, and the other part is used as the ground plane of the antenna. The feed component is disposed to feed the low-frequency antenna element, so that the low-frequency antenna element can receive or transmit an electromagnetic signal. The short-circuit transmission line is disposed at the metal layer, and the short-circuit transmission line is disposed between the positive electrode and the negative electrode of the low-frequency antenna element, so that the low-frequency antenna element can suppress an inter-frequency signal, to improve isolation between antenna elements at different frequencies, and improve operating efficiency of the low-frequency antenna element. Compared with the related technology in which the inter-frequency signal is suppressed by using a cascaded filter, the low-frequency antenna element provided in this embodiment of this application can suppress the inter-frequency signal by connecting only the short-circuit transmission line to the metal layer. No other devices need to be added in this embodiment of this application, and therefore a volume of the low-frequency antenna element can be reduced. This facilitates miniaturization development of the low-frequency antenna element, and can lower costs.

In an embodiment, a length from the positive electrode of the low-frequency antenna element to the negative electrode of the low-frequency antenna element along an extension path of the short-circuit transmission line is a wavelength corresponding to any frequency in a suppressed frequency band of the low-frequency antenna element.

An extension length of the short-circuit transmission line is set to be equal to the wavelength corresponding to the any frequency in the suppressed frequency band of the low-frequency antenna element, so that when the low-frequency antenna element operates at a fundamental wave, the short-circuit transmission line is equivalent to an open circuit, a bandpass is formed, and there is no impact on fundamental wave radiation; and when the low-frequency antenna element operates in the suppressed frequency band, the short-circuit transmission line is equivalent to a short circuit, a notch is formed, a current is confined to the short-circuit transmission line, and a zero is formed, to suppress an inter-frequency signal, so as to improve isolation of the low-frequency antenna element and improve operating efficiency of the low-frequency antenna element.

In an embodiment, a length from the positive electrode of the low-frequency antenna element to the negative electrode of the low-frequency antenna element along an extension path of the short-circuit transmission line is a wavelength corresponding to a center frequency in a suppressed frequency band of the low-frequency antenna element.

In an embodiment, a resonance frequency of the low-frequency antenna element is 2.45 GHz, and the suppressed frequency band of the low-frequency antenna element is 5.15 GHz to 5.85 GHz.

In an embodiment, the short-circuit transmission line includes a first extension section, a second extension section, and a connection section. At least a part of the first extension section and a partial structure of the second extension section are disposed opposite to each other, there is a second slot between the first extension section extending in the second direction and the second extension section extending in the second direction, and one end of the second slot communicates with the first slot. The connection section is located at an end that is of the second slot and that is away from the first slot. One end of the connection section is connected to the first extension section, and the other end is connected to the second extension section.

The short-circuit transmission line is disposed as a structure including the first extension section, the second extension section, and the connection section, so that the second slot is formed between the first extension section extending in the second direction and the second extension section extending in the second direction. Therefore, a length of the short-circuit transmission line can be extended without increasing a length of the metal layer in the second direction, to reduce impact of addition of the short-circuit transmission line on a size of the low-frequency antenna element and meet a length requirement of the short-circuit transmission line, so as to suppress an inter-frequency signal.

In an embodiment, the first extension section is of an L-shaped structure, a part of the first extension section extends in the first direction, and a part of the first extension section extends in the second direction. The second extension section is of an L-shaped structure, a part of the second extension section extends in the first direction, and a part of the second extension section extends in the second direction. A part of the first slot is formed between the part that is of the first extension section and that extends in the first direction and the part that is of the second extension section and that extends in the first direction.

The first extension section is disposed as the L-shaped structure, and the second extension section is disposed as the L-shaped structure, so that lengths of the first extension section and the second extension section are more nearly equal to each other, to increase symmetry of the low-frequency antenna element, so as to improve pattern performance of the low-frequency antenna element.

In an embodiment, in the first direction, the second extension section is closer to a center position of the metal layer than the first extension section. The short-circuit transmission line is a partial structure of the ground plane, the first extension section is connected to the positive electrode of the low-frequency antenna element, and the second extension section is connected to the negative electrode of the low-frequency antenna element. The first extension section extending in the first direction is a partial structure of the radiator, and the second extension section extending in the first direction is a partial structure of the ground plane.

The first extension section extending in the first direction is disposed as the partial structure of the radiator, and the second extension section extending in the first direction is disposed as the partial structure of the ground plane, so that the short-circuit transmission line and the partial structure of the ground plane are integrated, to reduce a size of the ground plane, so as to reduce a size of the low-frequency antenna element, thereby facilitating miniaturization development of the low-frequency antenna element.

In an embodiment, a part of the second extension section extending in the second direction is disposed at an interval from the ground plane; or the second extension section extending in the second direction is a partial structure of the ground plane.

In an embodiment, in the first direction, the second extension section is closer to a center position of the metal layer than the first extension section. The short-circuit transmission line is a partial structure of the radiator, the first extension section is connected to the negative electrode of the low-frequency antenna element, and the second extension section is connected to the positive electrode of the low-frequency antenna element. The first extension section extending in the first direction is a partial structure of the ground plane, and the second extension section extending in the first direction is a partial structure of the radiator.

The first extension section extending in the first direction is disposed as the partial structure of the ground plane, and the second extension section extending in the first direction is disposed as the partial structure of the radiator, so that the short-circuit transmission line and the partial structure of the radiator are integrated, to reduce a size of the ground plane, so as to reduce a size of the low-frequency antenna element, thereby facilitating miniaturization development of the low-frequency antenna element.

In an embodiment, a part of the second extension section extending in the second direction is disposed at an interval from the radiator; or the second extension section extending in the second direction is a partial structure of the radiator.

In an embodiment, the feed component includes a feeder. A positive electrode of the feeder is connected to the radiator, and a negative electrode of the feeder is connected to the ground plane.

The feed component is disposed to include the feeder, so that a structure of the feed component can be simplified, to lower costs.

In an embodiment, the feed component further includes a feed stub. The feed stub is located in the first slot, the negative electrode of the feeder is connected to the ground plane, the positive electrode of the feeder is connected to the feed stub, and the feed stub is coupled to the radiator.

The feed component is disposed to include the feed stub, so that impedance of the low-frequency antenna element at 2.45 GHz can be adjusted, to ensure antenna performance at 2.45 GHz.

In an embodiment, the feed stub is a linear-shaped feed stub, a T-shaped feed stub, a U-shaped feed stub, or a special-shaped feed stub.

In an embodiment, the ground plane is of a U-shaped structure. The U-shaped structure includes a top wall, a first sidewall, and a second sidewall. The first sidewall and the second sidewall are disposed opposite to each other, and the first sidewall and the second sidewall are respectively located at two ends of the top wall. An opening of the U-shaped structure faces a surface that is of the ground plane and that is away from the radiator, and the top wall is located at an end that is of the ground plane and that is close to the radiator.

The ground plane is disposed as the U-shaped structure, so that when the negative electrode of the feed component is connected to the ground plane, a partial current on the negative electrode of the feed component can be released from the ground plane.

In an embodiment, there are two short-circuit transmission lines; and the two short-circuit transmission lines are symmetrically disposed on two sides of the metal layer in the first direction.

The two short-circuit transmission lines are disposed, and the two short-circuit transmission lines are symmetrically disposed on the two sides of the metal layer in the first direction, so that the ground plane can be of a symmetric structure, to improve pattern performance of the low-frequency antenna element.

According to a second aspect, an embodiment of this application provides a high-frequency antenna element. The high-frequency antenna element includes a metal layer and a substrate. The metal layer is located on a surface of the substrate, and the metal layer includes a ground plane, a radiator, and open-circuit transmission lines. A first slot is disposed between the ground plane and the radiator. The first slot extends in a first direction, and the ground plane and the radiator are respectively at two ends of the first slot in a second direction. The first direction is perpendicular to the second direction. A feed component is disposed in the first slot. The radiator is connected to a positive electrode of the feed component, a positive electrode of the high-frequency antenna element is located on the radiator, the ground plane is connected to a negative electrode of the feed component, and a negative electrode of the high-frequency antenna element is located on the ground plane. The open-circuit transmission lines include a first open-circuit transmission line and a second open-circuit transmission line, and the first open-circuit transmission line and the second open-circuit transmission line are disposed at an interval. One end of the first open-circuit transmission line is connected to one of the positive electrode or the negative electrode of the high-frequency antenna element, and the other end is open-circuit. One end of the second open-circuit transmission line is connected to the other one of the positive electrode or the negative electrode of the high-frequency antenna element, and the other end is open-circuit. The second direction is an extension direction of the metal layer.

The first open-circuit transmission line and the second open-circuit transmission line are disposed at the metal layer, the first open-circuit transmission line and the second open-circuit transmission line are disposed at an interval, one end of the first open-circuit transmission line is connected to one of the positive electrode or the negative electrode of the high-frequency antenna element, and one end of the second open-circuit transmission line is connected to the other one of the positive electrode or the negative electrode of the high-frequency antenna element, so that one open-circuit transmission line is connected to each of the positive electrode and the negative electrode of the high-frequency antenna element, to suppress an inter-frequency signal of the high-frequency antenna element, and improve isolation between different antenna elements, so as to improve operating efficiency of the high-frequency antenna element.

In an embodiment, a sum of an extension length of the first open-circuit transmission line and an extension length of the second open-circuit transmission line is less than or equal to a wavelength corresponding to a resonance frequency of the high-frequency antenna element.

The sum of the extension length of the first open-circuit transmission line and the extension length of the second open-circuit transmission line is less than or equal to the wavelength corresponding to the resonance frequency of the high-frequency antenna element, so that when the high-frequency antenna element operates at a fundamental wave, it is equivalent to an open circuit, a bandpass structure is formed, and therefore there is no impact on fundamental wave radiation of the high-frequency antenna element; and when the high-frequency antenna element operates in a suppressed frequency band, the first open-circuit transmission line and the second open-circuit transmission line are equivalent to a short circuit, a notch is formed, and a zero is implemented, to suppress an inter-frequency signal, so as to improve isolation from a low-frequency antenna element, and improve operating efficiency of the high-frequency antenna element.

In an embodiment, the resonance frequency of the high-frequency antenna element is 5.5 GHz, and a suppressed frequency band of the high-frequency antenna element is 2.4 GHz to 2.48 GHz.

In an embodiment, the first open-circuit transmission line is located on an outer side of the second open-circuit transmission line, and the second open-circuit transmission line is a partial structure of the ground plane or the radiator.

The second open-circuit transmission line is disposed as a part of the ground plane or the radiator, so that the second open-circuit transmission line and the ground plane or the radiator can be integrally designed, to reduce a size of the high-frequency antenna element, thereby facilitating miniaturization development of the high-frequency antenna element.

In an embodiment, the first open-circuit transmission line includes an extension portion. The extension portion is of an L-shaped structure, a part of the extension portion extends in the first direction, and a part of the extension portion extends in the second direction. The extension portion is disposed on a side that is of the first open-circuit transmission line and that is away from a center position of the ground plane, a free end of the extension portion extending in the first direction is connected to an end that is of the first open-circuit transmission line and that is away from the first slot, and the part that is of the extension portion and that extends in the second direction and a part that is of the first open-circuit transmission line and that is opposite to the second open-circuit transmission line are disposed at an interval.

The extension portion is disposed, so that a length of the first open-circuit transmission line can be extended, and therefore a length of the second short-circuit transmission line can be reduced, to reduce a length of the ground plane in the second direction, so as to reduce a volume of the high-frequency antenna element, thereby facilitating miniaturization development of the high-frequency antenna element. In addition, the extension portion is disposed, so that design flexibility of the first open-circuit transmission line and the second open-circuit transmission line can be improved. In this way, first open-circuit transmission lines and second open-circuit transmission lines with different lengths can be designed based on different suppressed frequency bands, thereby improving adaptability of the high-frequency antenna element.

In an embodiment, the first open-circuit transmission line further includes a matching stub. The matching stub is an L-shaped matching stub, one end of the L-shaped matching stub is connected to the first open-circuit transmission line, and the other end extends in the second direction toward the extension portion.

The matching stub is disposed, so that an impedance characteristic of the first open-circuit transmission line can be increased, to adjust a radiation frequency band of the high-frequency antenna element. In addition, the matching stub is added, so that the first open-circuit transmission line can be made more similar to a symmetric structure, to improve pattern performance of the high-frequency antenna element.

In an embodiment, the feed component includes a feeder. A positive electrode of the feeder is connected to the radiator, and a negative electrode of the feeder is connected to the ground plane.

The feed component is disposed to include the feeder, so that a structure of the feed component can be simplified, to lower costs.

In an embodiment, the feed component further includes a feed stub. The feed stub is located in the first slot, the negative electrode of the feeder is connected to the ground plane, the positive electrode of the feeder is connected to the feed stub, and the feed stub is coupled to the radiator.

The feed component is disposed to include the feed stub, so that impedance of the high-frequency antenna element at 5.5 GHz can be adjusted, to ensure antenna performance at 5.5 GHz.

In an embodiment, the feed stub is a linear-shaped feed stub, a T-shaped feed stub, a U-shaped feed stub, or a special-shaped feed stub.

In an embodiment, the feed component includes a feeder. A negative electrode of the feeder is connected to the ground plane, a positive electrode of the feeder is connected to the first open-circuit transmission line, and the first open-circuit transmission line is coupled to the radiator.

In an embodiment, the ground plane is of a U-shaped structure. The U-shaped structure includes a top wall, a first sidewall, and a second sidewall. The first sidewall and the second sidewall are disposed opposite to each other, and the first sidewall and the second sidewall are respectively located at two ends of the top wall. An opening of the U-shaped structure faces a surface that is of the ground plane and that is away from the radiator, and the top wall is located at an end that is of the ground plane and that is close to the radiator.

The ground plane is disposed as the U-shaped structure, so that when the negative electrode of the feed component is connected to the ground plane, a partial current on the negative electrode of the feed component can be released from the ground plane.

In an embodiment, there are two groups of first open-circuit transmission lines and second open-circuit transmission lines; and the two groups of first open-circuit transmission lines and second open-circuit transmission lines are symmetrically disposed at two ends of the metal layer in the first direction.

The two groups of first open-circuit transmission lines and second open-circuit transmission lines are disposed, and the two groups of first open-circuit transmission lines and second open-circuit transmission lines are symmetrically disposed on two sides of the metal layer in the first direction, so that the ground plane can be of a symmetric structure, to improve pattern performance of the high-frequency antenna element.

According to a third aspect, an embodiment of this application provides an antenna array, including at least one low-frequency antenna element provided in the first aspect and at least one high-frequency antenna element provided in the second aspect. The low-frequency antenna element and the high-frequency antenna element are alternately disposed at an interval.

The antenna array is disposed to include the low-frequency antenna element in the first aspect and the high-frequency antenna element in the second aspect, and the low-frequency antenna element and the high-frequency antenna element are alternately disposed at an interval, so that the antenna array in this embodiment of this application can transmit and receive electromagnetic waves at different frequencies, and the antenna array is an inter-frequency antenna array. In this way, bandwidth of the antenna array can be increased, thereby improving applicability of the antenna array. In addition, because the low-frequency antenna element in the first aspect is a 2.45 GHz antenna element and can suppress a frequency band of 5.15 GHz to 5.85 GHz, and the high-frequency antenna element in the second aspect is a 5 GHz antenna element and can suppress a frequency band of 2.4 GHz to 2.48 GHz, that is, both the low-frequency antenna element in the first aspect and the high-frequency antenna element in the second aspect have a filtering function, isolation of the antenna array can be improved, so that no mutual interference is generated between the low-frequency antenna element and the high-frequency antenna element. Furthermore, the low-frequency antenna element in the first aspect and the high-frequency antenna element in the second aspect have simple structures, small volumes, and low costs, and therefore a volume of the antenna array can be reduced, thereby facilitating miniaturization development of the antenna array.

According to a fourth aspect, an embodiment of this application provides a terminal device, including the antenna array provided in the third aspect.

According to the terminal device provided in this embodiment of this application, the antenna array provided in the third aspect is disposed, so that assembly space reserved in the terminal device for mounting the antenna array can be reduced, thereby facilitating miniaturization development of the terminal device.

### BRIEF DESCRIPTION OF DRAWINGS

FIG. 1 is a diagram of a structure of a radio frequency front-end system;

FIG. 2 is a diagram of a structure of another radio frequency front-end system;

FIG. 3A is a diagram of an application scenario of an antenna array according to an embodiment of this application;

FIG. 3B is a diagram of a framework structure of a radio frequency front-end system of an antenna array according to an embodiment of this application;

FIG. 4 is a diagram of structures of a low-frequency antenna element and a high-frequency antenna element in an antenna array according to an embodiment of this application;

FIG. 5 is a diagram of exploded structures of a low-frequency antenna element and a high-frequency antenna element in an antenna array according to an embodiment of this application;

FIG. 6 is a diagram of structures of metal layers and substrates of a low-frequency antenna element and a high-frequency antenna element in an antenna array according to an embodiment of this application;

FIG. 7 is a diagram of an enlarged structure of a portion A in FIG. 6;

FIG. 8 is a diagram of an enlarged structure of a portion B in FIG. 6;

FIG. 9A is a circuit diagram of a low-frequency antenna element with a short-circuit transmission line connected in parallel according to an embodiment of this application;

FIG. 9B is an equivalent circuit diagram of a low-frequency antenna element according to an embodiment of this application;

FIG. 10 shows curves of a standing wave and an impedance characteristic of a short-circuit transmission line of a low-frequency antenna element according to an embodiment of this application;

FIG. 11 is an equivalent circuit diagram when an operating frequency of a low-frequency antenna element is f₁ according to an embodiment of this application;

FIG. 12 is a diagram of electric field distribution on a filtering structure of a low-frequency antenna element according to an embodiment of this application;

FIG. 13 is an equivalent circuit diagram when an operating frequency of a low-frequency antenna element is 2f₁ according to an embodiment of this application;

FIG. 14 is a diagram of electric field distribution on a filtering structure of a low-frequency antenna element according to an embodiment of this application;

FIG. 15 is a design idea diagram of a low-frequency antenna element in an antenna array shown in FIG. 7;

FIG. 16 is a diagram of a partial structure of a low-frequency antenna element according to an embodiment of this application;

FIG. 17 is a design idea diagram of the low-frequency antenna element shown in FIG. 16;

FIG. 18 is a diagram of electric field distribution on a filtering structure of a low-frequency antenna element according to an embodiment of this application;

FIG. 19 is a diagram of electric field distribution on a filtering structure of a low-frequency antenna element according to an embodiment of this application;

FIG. 20A is a diagram of a partial structure of a low-frequency antenna element according to another embodiment of this application;

FIG. 20B is a diagram of a partial structure of a low-frequency antenna element according to another embodiment of this application;

FIG. 21A is a diagram of a partial structure of a low-frequency antenna element according to another embodiment of this application;

FIG. 21B is a diagram of a partial structure of a low-frequency antenna element according to another embodiment of this application;

FIG. 22 is a circuit diagram of a part of a metal layer of a high-frequency antenna element according to an embodiment of this application;

FIG. 23 is a design idea diagram of a high-frequency antenna element according to an embodiment of this application;

FIG. 24 is an equivalent circuit diagram of a high-frequency antenna element according to an embodiment of this application;

FIG. 25 shows curves of a standing wave and an impedance characteristic of an open-circuit transmission line of a high-frequency antenna element according to an embodiment of this application;

FIG. 26 is an equivalent circuit diagram when an operating frequency of a high-frequency antenna element is f₂/2 according to an embodiment of this application;

FIG. 27 is a diagram of electric field distribution on a filtering structure of a high-frequency antenna element according to an embodiment of this application;

FIG. 28 is an equivalent circuit diagram when an operating frequency of a high-frequency antenna element is f₂ according to an embodiment of this application;

FIG. 29 is a diagram of electric field distribution on a filtering structure of a high-frequency antenna element according to an embodiment of this application;

FIG. 30 is a diagram of a partial structure of a high antenna element according to another embodiment of this application;

FIG. 31 is a diagram of a partial structure of a high-frequency antenna element according to another embodiment of this application;

FIG. 32 is a diagram of a partial structure of a high-frequency antenna element according to another embodiment of this application;

FIG. 33 is a diagram of a partial structure of a high-frequency antenna element according to another embodiment of this application;

FIG. 34 is an equivalent circuit diagram of a high-frequency antenna element according to an embodiment of this application;

FIG. 35 shows curves of a standing wave and an impedance characteristic of an open-circuit transmission line of a high-frequency antenna element according to an embodiment of this application;

FIG. 36 are S-parameter Smith charts before and after a matching stub is added to an open-circuit transmission line of a high-frequency antenna element according to an embodiment of this application;

FIG. 37 is an equivalent circuit diagram when an operating frequency of a high-frequency antenna element is f₂/2 according to an embodiment of this application;

FIG. 38 is a diagram of electric field distribution on a filtering structure of a high-frequency antenna element according to an embodiment of this application;

FIG. 39 is an equivalent circuit diagram when an operating frequency of a high-frequency antenna element is f₂ according to an embodiment of this application;

FIG. 40 is a diagram of electric field distribution on a filtering structure of a high-frequency antenna element according to an embodiment of this application;

FIG. 41 is a diagram of a partial structure of a high-frequency antenna element according to another embodiment of this application;

FIG. 42 is a diagram of a partial structure of a high-frequency antenna element according to another embodiment of this application;

FIG. 43 is a diagram of a partial structure of a high-frequency antenna element according to another embodiment of this application;

FIG. 44 is a design idea diagram of the high-frequency antenna element shown in FIG. 43;

FIG. 45 is a diagram of structures of feeders in a low-frequency antenna element and a high-frequency antenna element according to an embodiment of this application;

FIG. 46 is an S-parameter diagram of an antenna array according to an embodiment of this application;

FIG. 47 is an efficiency curve diagram of an antenna array according to an embodiment of this application;

FIG. 48 shows a pattern of an antenna array in a 2.4G frequency band according to an embodiment of this application;

FIG. 49 shows a pattern of an antenna array in a 5G frequency band according to an embodiment of this application;

FIG. 50 is a diagram of current distribution when an operating frequency band of a low-frequency antenna element in an antenna array is in a 2.4G frequency band according to an embodiment of this application;

FIG. 51 is a diagram of current distribution when an operating frequency band of a low-frequency antenna element in an antenna array is in a 5G frequency band according to an embodiment of this application;

FIG. 52 is a diagram of current distribution when an operating frequency band of a high-frequency antenna element in an antenna array is in a 2.4G frequency band according to an embodiment of this application;

FIG. 53 is a diagram of current distribution when an operating frequency band of a high-frequency antenna element in an antenna array is in a 5G frequency band according to an embodiment of this application;

FIG. 54 is a diagram of partial structures of a low-frequency antenna element and a high-frequency antenna element in an antenna array according to an embodiment of this application;

FIG. 55 is an S-parameter diagram of the antenna array shown in FIG. 54;

FIG. 56 is an efficiency curve diagram of the antenna array shown in FIG. 54;

FIG. 57 shows a pattern of the antenna array shown in FIG. 54 in a 2.4G frequency band;

FIG. 58 shows a pattern of the antenna array shown in FIG. 54 in a 5G frequency band;

FIG. 59 is a diagram of current distribution when an operating frequency band of a high-frequency antenna element in the antenna array shown in FIG. 54 is in a 2.4G frequency band;

FIG. 60 is a diagram of current distribution when an operating frequency band of a high-frequency antenna element in the antenna array shown in FIG. 54 is in a 5G frequency band;

FIG. 61 is a diagram of partial structures of a low-frequency antenna element and a high-frequency antenna element in an antenna array according to an embodiment of this application;

FIG. 62 is an S-parameter diagram of the antenna array shown in FIG. 61;

FIG. 63 is an efficiency curve diagram of the antenna array shown in FIG. 61;

FIG. 64 shows a pattern of an antenna array in a 2.4G frequency band according to an embodiment of this application;

FIG. 65 shows a pattern of an antenna array in a 5G frequency band according to an embodiment of this application;

FIG. 66 is a diagram of current distribution when an operating frequency band of a low-frequency antenna element in an antenna array is in a 2.4G frequency band according to an embodiment of this application; and

FIG. 67 is a diagram of current distribution when an operating frequency band of a low-frequency antenna element in an antenna array is in a 5G frequency band according to an embodiment of this application.

### DESCRIPTION OF REFERENCE NUMERALS

10 and 1000: radio frequency front-end system; 10a, 10b, 1000a, 1000b, 1000c, and 1000d: radio frequency link;
11: filter; 12 and 110: front-end module; 13: antenna element;
14 and 120: chip; 20: router; 30: terminal device;
130: low-frequency antenna element; 131: short-circuit transmission line; 1311: first extension section;
1312: second extension section; 1313: connection section;
140: high-frequency antenna element; 141: first open-circuit transmission line; 142: second open-circuit transmission line;
143: bent portion; 144: extension portion; 145: matching stub;
150: accommodation cavity; 160: substrate; 161: fastening position;
170: metal layer; 171: radiator; 1711: phase shifter; 1712: radiating element;
172: ground plane; 1721: top wall; 1722: first sidewall; 1723: second sidewall;
173: first slot; 174: feed component; 1741: feeder; 17411: core layer;
17412: dielectric layer; 17413: outer conductor layer; 1742: feed stub;
175: second slot; 176: third slot; 177: coupling slot;
180: microstrip low-pass filter; and 190: discrete LC notch filter.

### DESCRIPTION OF EMBODIMENTS

Terms used in implementations of this application are merely used to explain specific embodiments of this application, and are not intended to limit this application.

Unless otherwise required in the context, the term “comprise” and other forms thereof such as the third-person singular form “comprises” and the present participle form “comprising” throughout this specification and claims are construed as an open and inclusive meaning, that is, “including but not limited to”. In descriptions of this specification, terms such as “one embodiment”, “some embodiments”, “example embodiments”, “example”, or “some examples” are intended to indicate that specific features, structures, materials, or characteristics related to the embodiment or example are included in at least one embodiment or example of the present disclosure. The foregoing schematic representations of the terms do not necessarily refer to a same embodiment or example. In addition, the specific features, structures, materials, or characteristics may be included in any one or more embodiments or examples in any appropriate manner.

In addition, in this application, position terms such as “front” and “rear” are defined relative to illustrative positions of components in the accompanying drawings. It should be understood that these position terms are relative concepts and are used for relative description and clarification, and may vary accordingly based on a change in positions at which the components are placed in the accompanying drawings.

In embodiments of this application, the term “and/or” describes merely an association relationship between associated objects and indicates that three relationships may exist. For example, A and/or B may indicate the following three cases: Only A exists, both A and B exist, and only B exists. In addition, the character “/” in this specification usually indicates an “or” relationship between associated objects.

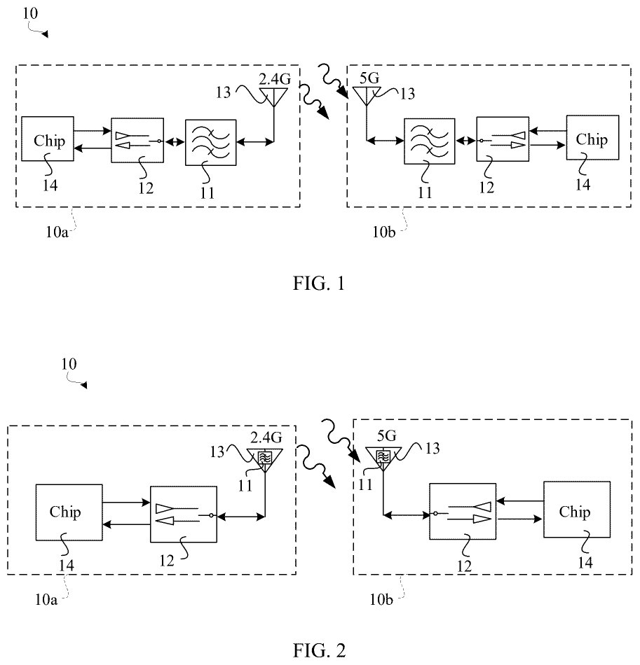

To eliminate mutual interference between inter-frequency antennas, in the related technology, a cascaded filter is used. As shown in FIG. 1, a radio frequency front-end system 10 includes a radio frequency link 10a and a radio frequency link 10b. Each of the radio frequency link 10a and the radio frequency link 10b includes a chip 14, a front-end module 12, and an antenna element 13. Frequencies of antenna elements 13 on the radio frequency link 10a and the radio frequency link 10b are different. A filter 11 is disposed between each antenna element 13 and the front-end module 110. The chip 14 is configured to provide a radio frequency signal to the antenna element 13. A chip 14 connected to a 2.4G antenna element provides a 2.4G radio frequency signal, and a chip 14 connected to a 5G antenna element provides a 5G radio frequency signal.

The filter 11 is disposed between the front-end module 12 and the antenna element 13, so that interference caused by mutual coupling between antennas can be reduced by using an out-of-band suppression characteristic of the filter 11. However, addition of the filter 11 results in an additional insertion loss, an increase in link costs, and a reduction in efficiency of the antenna element 13. In addition, this results in an increase in a volume of the radio frequency front-end system 10, and is inconducive to miniaturization development of the radio frequency front-end system 10.

In the related technology, as shown in FIG. 2, the filter 11 and the antenna element 13 may alternatively be integrally designed. For example, a filtering structure may be integrated into a feed line of an antenna (not shown in the figure). Compared with a manner in which the antenna and the filter 11 are independently designed and then cascaded, this can implement an appropriate reduction in a size. However, an insertion loss of the filter 11 is not resolved, and a double-sided board structure with costs higher than those of a single-sided board is required. In addition, bandstop filtering may be implemented by combining a driven patch and a parasitic patch (not shown in the figure). A zero is generated at a high frequency, and a short-circuit patch is introduced to generate another zero at a low frequency. In this way, 15 dB out-of-band suppression is implemented without an additional filter circuit. However, in this manner of combining the driven patch and the parasitic patch, the antenna element needs to be disposed as a multi-layer structure. However, the multi-layer design of the antenna element 13 results in an increase in a cross-sectional height of the antenna and a large volume, and requires a large amount of mounting space. Therefore, an application scenario of the antenna element 13 is limited.

To resolve the foregoing technical problem, embodiments of this application provide a low-frequency antenna element 130 with a filtering function and a high-frequency antenna element 140 with a filtering function. When a same antenna array includes both the low-frequency antenna element 130 and the antenna element 140, interference between inter-frequency antenna elements can be reduced, thereby lowering a blocking risk in a radio frequency link local area network.

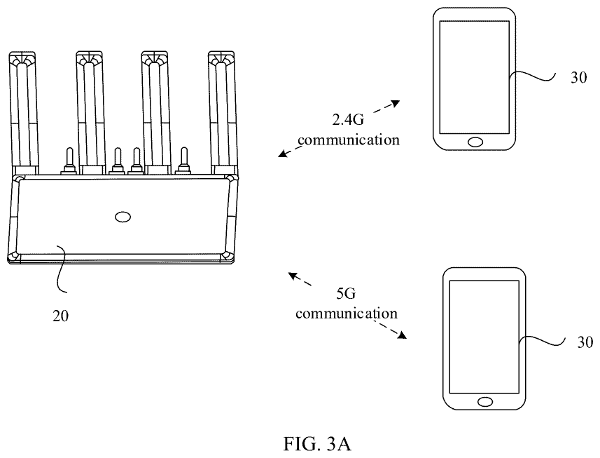

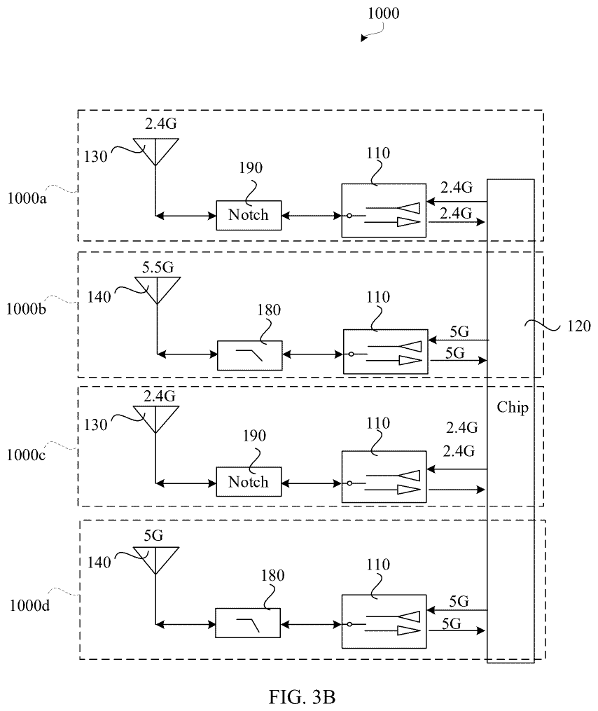

The antenna array provided in embodiments of this application is described below with reference to FIG. 3A to FIG. 67.

An embodiment of this application provides an antenna array (not shown in the figure) that can be used in a terminal device 30. The communication device may be a router 20, a mobile phone, a computer, or the like. In this embodiment, a specific type of the terminal device 30 is not further limited.

The antenna array may be a dipole antenna or a dipole array antenna. For example, the antenna array is a series-fed dipole array antenna. The antenna array is an inter-frequency antenna. For example, the antenna array is an inter-frequency antenna including two frequency bands: Wi-Fi 2.4G and Wi-Fi 5G. In this embodiment, an inter-frequency antenna is an antenna that can receive and send electromagnetic waves of signals at different frequencies.

This embodiment of this application may be applied to the terminal device 30 such as the wireless router 20. An application scenario is shown in FIG. 3A. The application scenario includes the terminal device 30 such as the wireless router 20 and a mobile phone, and further includes a wireless communication system disposed in the wireless router 20 and the antenna array provided in this embodiment of this application. The antenna array in this embodiment of this application can reduce mutual coupling between different antenna elements in the antenna array in a process of operating in both Wi-Fi 2.4G and Wi-Fi 5G, lower a blocking risk in a Wi-Fi 2.4G link and a Wi-Fi 5G link, and improve a throughput rate.

For ease of description, in this embodiment, an x direction in the figure is a first direction, namely, a width direction of a metal layer 170, and a y direction in the figure is a second direction, namely, an extension direction of the metal layer 170.

An embodiment of this application provides an antenna array used in a radio frequency front-end system 1000 shown in FIG. 3B. The radio frequency front-end system 1000 includes four radio frequency links: a radio frequency link 1000a, a radio frequency link 1000b, a radio frequency link 1000c, and a radio frequency link 1000d. Each of the radio frequency link 1000a, the radio frequency link 1000b, the radio frequency link 1000c, and the radio frequency link 1000d includes a chip 120, a front-end module 110, and an antenna element. Frequencies of antenna elements on the radio frequency link 1000a, the radio frequency link 1000b, the radio frequency link 1000c, and the radio frequency link 1000d are different. The four radio frequency links are disposed in parallel, and resonance frequencies of antenna elements on two adjacent radio frequency links are different.

For example, the antenna elements on the two adjacent radio frequency links are respectively a low-frequency antenna element 130 and a high-frequency antenna element 140. A resonance frequency f₁ of the low-frequency antenna element 130 may be 2.45 GHz, and a resonance frequency f₂ of the high-frequency antenna element 140 may be 5.5 GHz. Certainly, in another embodiment, the resonance frequencies of the low-frequency antenna element 130 and the high-frequency antenna element 140 may alternatively be other values. In this embodiment of this application, the resonance frequencies of the low-frequency antenna element 130 and the high-frequency antenna element 140 are not further limited. In this embodiment, the resonance frequency is a frequency at which the antenna best receives a signal frequency.

In this embodiment, the low-frequency antenna element 130 may be a Wi-Fi 2.4G antenna element, and the high-frequency antenna element 140 may be a Wi-Fi 5G antenna element. A discrete LC notch filter 190 may be further disposed between the Wi-Fi 2.4G antenna element and the radio frequency front-end module 110, to suppress a high-order harmonic. Notch in the figure represents the discrete LC notch filter 190. A microstrip low-pass filter 180 may be further disposed between the Wi-Fi 5G antenna element and the radio frequency front-end module 110, to suppress a low-frequency harmonic.

It should be noted that in this embodiment, models of the discrete LC notch filter 190 and the microstrip low-pass filter 180 are not further limited. In addition, resonance frequencies of the Wi-Fi 2.4G antenna element, a 2.4G antenna, and the low-frequency antenna element 130 are all 2.45 GHz, and resonance frequencies of the Wi-Fi 5G antenna element, a 5G antenna, and the high-frequency antenna element 140 are all 5.5 GHz.

It should be noted that the four antenna elements on the four radio frequency links form an antenna array. Certainly, a quantity of antenna elements in the antenna array is not limited. In some other embodiments, the antenna array may alternatively include two, three, five, six, seven, eight, or more antenna elements. In this embodiment, the quantity of antenna elements is not limited.

A low-frequency antenna element 130 and a high-frequency antenna element 140 on a group of adjacent radio frequency links in the antenna array are used as an example below for description.

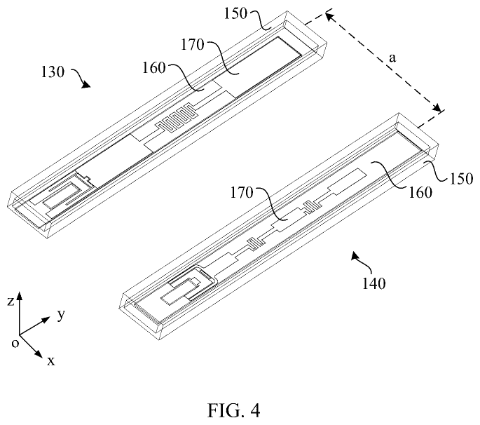

As shown in FIG. 4, each of the low-frequency antenna element 130 and the high-frequency antenna element 140 may be disposed in an accommodation cavity 150, the low-frequency antenna element 130 and the high-frequency antenna element 140 that are adjacent to each other are disposed at an interval, and a distance a between the low-frequency antenna element 130 and the high-frequency antenna element 140 that are adjacent to each other may be 60 mm. Certainly, in another embodiment, the distance a between the low-frequency antenna element 130 and the high-frequency antenna element 140 that are adjacent to each other may alternatively be another value. For example, when a terminal device 30 has a large size, the distance between the low-frequency antenna element 130 and the high-frequency antenna element 140 may be set to a large value; or when a terminal device 30 has a small size, the distance between the low-frequency antenna element 130 and the high-frequency antenna element 140 may be set to a small value. This may be specifically set based on a specific situation, and is not further limited in this embodiment.

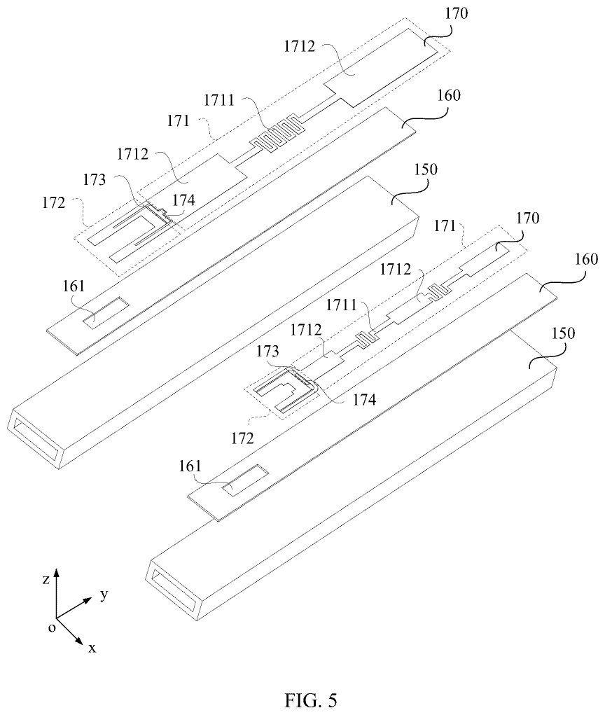

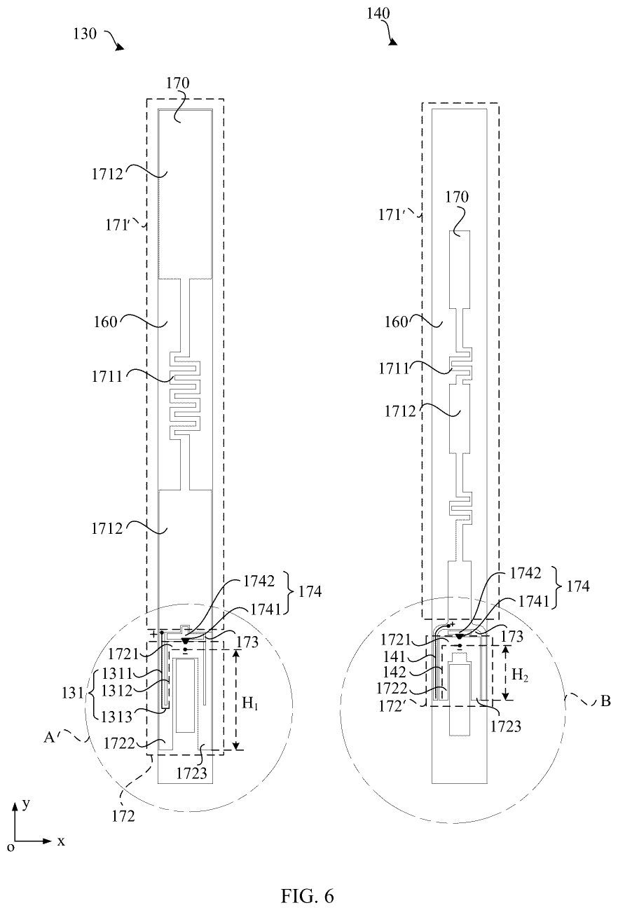

As shown in FIG. 5 and FIG. 6, each of the low-frequency antenna element 130 and the high-frequency antenna element 140 may include a substrate 160 and a metal layer 170. The metal layer 170 is disposed on a surface of the substrate 160. A fastening position 161 may be disposed at an end that is of the substrate 160 and that is close to a ground plane 172, to process and fasten the antenna element and meet a balun effect of the antenna element. For example, the fastening position 161 may be a via structure. Certainly, in another embodiment, the fastening position 161 may alternatively be in another shape. This is not further limited in this embodiment.

The metal layer 170 includes a first slot 173. The first slot 173 is disposed in an x direction, and the ground plane 172 and a radiator 171 are respectively on two sides of the first slot 173. A feeder 1741 (not shown in the figure) is disposed between the ground plane 172 and the radiator 171. The feeder 1741 is configured to electrically connect the ground plane 172 and the radiator 171. For example, a positive electrode of the feeder 1741 is connected to the radiator 171, and a negative electrode of the feeder 1741 is connected to the ground plane 172.

For example, the ground plane 172 may be of a U-shaped structure. The U-shaped structure includes a top wall 1721, a first sidewall 1722, and a second sidewall 1723. The first sidewall 1722 and the second sidewall 1723 are disposed opposite to each other, and the first sidewall 1722 and the second sidewall 1723 are respectively located at two ends of the top wall 1721. An opening of the U-shaped structure faces a surface that is of the ground plane 172 and that is away from the radiator 171, and the top wall 1721 is located at an end that is of the ground plane 172 and that is close to the radiator 171. The ground plane 172 is disposed as the U-shaped structure, so that when a negative electrode of a feed component 174 is connected to the ground plane 172, a partial current on the negative electrode of the feed component 174 can be released from the ground plane 172.

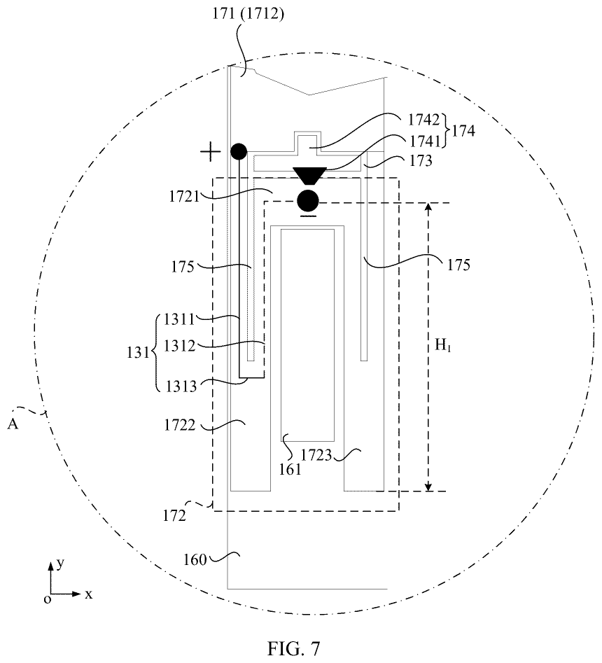

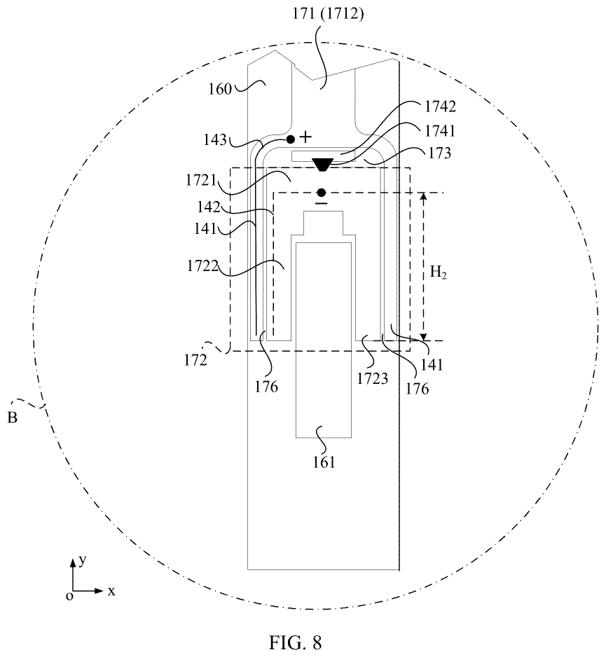

For ease of description, an opening end of the U-shaped structure is used as a first end of the ground plane 172, an end that is of the U-shaped structure and that is close to the first slot 173 is used as a second end of the ground plane 172, the top wall 1721 is located at the second end of the ground plane 172, and a distance between a center position of the top wall 1721 and the first end of the ground plane 172 in a y direction is a length of the plate. A length H₁ of the ground plane 172 of the low-frequency antenna element 130 is ¼ of a wavelength corresponding to a resonance frequency of the low-frequency antenna element 130, for example, λ_{2.45 GHz}/4 (as shown in FIG. 7). A length H₂ of the ground plane 172 of the high-frequency antenna element 140 is ¼ of a wavelength corresponding to a resonance frequency of the high-frequency antenna element 140, for example, λ_{5.5 GHz}/4 (as shown in FIG. 8).

For ease of description, in this embodiment, both the low-frequency antenna element 130 and the high-frequency antenna element 140 may be used as antenna elements, and both the length H₁ of the ground plane 172 of the low-frequency antenna element 130 and the length H₂ of the ground plane 172 of the high-frequency antenna element 140 are lengths of the ground plane 172.

It should be noted that the length of the ground plane 172 is allowed to change within a specific error range. For example, the length may be considered as ¼ of a wavelength corresponding to a resonance frequency of the antenna element, provided that the length is within an error range of ±2 mm. Certainly, in some embodiments, the length of the ground plane 172 may alternatively be ⅓, ⅗, or the like of the wavelength corresponding to the resonance frequency of the antenna element, provided that the length is between ⅛ and ½ of the wavelength corresponding to the resonance frequency of the antenna element.

As shown in FIG. 6, in this embodiment, in the figure, the low-frequency antenna element 130 includes a metal layer 170 with a large size, the resonance frequency f₁ of the low-frequency antenna element 130 may be 2.45 GHz, and the corresponding wavelength is λ_{2.45 GHz}; and the high-frequency antenna element 140 includes a metal layer 170 with a small size, the resonance frequency f₂ of the high-frequency antenna element 140 may be 5.5 GHz, and the corresponding wavelength is λ_{5.5 GHz}. The length H₁ of the ground plane 172 of the low-frequency antenna element 130 may be λ_{2.45 GHz}/4, and the length H₂ of the ground plane 172 of the high-frequency antenna element 140 may be λ_{5.5 GHz}/4.

The radiator 171 of the low-frequency antenna element 130 includes two radiating elements 1712 and a phase shifter 1711. The two radiating elements 1712 are respectively located at two ends of the phase shifter 1711, and a radiating element 1712 close to the ground plane 172 is electrically connected to the ground plane 172. For example, direct feeding may be implemented between the radiating element 1712 and the ground plane 172 through the feeder 1741, or coupled feeding may be implemented through a feed stub 1742, or slot capacitive feeding may be implemented through a stub.

In direct feeding, direct feeding may be implemented through the feeder 1741, the positive electrode of the feeder 1741 is connected to the radiating element 1712, and the negative electrode of the feeder 1741 is connected to the ground plane 172. In coupled feeding implemented through the feed stub 1742, capacitive coupled feeding may be implemented through the feed stub 1742, the positive electrode of the feeder 1741 is connected to the feed stub 1742, the negative electrode of the feeder 1741 is connected to the ground plane 172, and the feed stub 1742 is coupled to the radiating element 1712. For example, the feed stub 1742 may be a linear-shaped feed stub 1742, a T-shaped feed stub 1742, a U-shaped feed stub 1742, a special-shaped feed stub 1742, or the like. A specific shape of the feed stub 1742 is not further limited.

In addition, the radiator 171 of the high-frequency antenna element 140 includes three radiating elements 1712 and two phase shifters 1711. One phase shifter 1711 is disposed between every two adjacent radiating elements 1712, and a radiating element 1712 close to the ground plane 172 is electrically connected to the ground plane 172. For example, the radiating element 1712 and the ground plane 172 may be electrically connected through coupling, or may be electrically connected through a feed stub 1742. The feed stub 1742 may be a linear-shaped feed stub 1742, a T-shaped feed stub 1742, a U-shaped feed stub 1742, a special-shaped feed stub 1742, or the like. A specific shape of the feed stub 1742 is not further limited.

It should be noted that the feed stub 1742 of the low-frequency antenna element 130 and the feed stub 1742 of the high-frequency antenna element 140 may be in a same shape or different shapes. This may be specifically set based on a specific situation. For example, the shape of the feed stub 1742 may be determined based on an impedance characteristic of the low-frequency antenna element 130 or the high-frequency antenna element 140. In this embodiment, the shape of the feed stub 1742 is not further limited.

In addition, a shape of the first slot 173 may match the shape of the feed stub 1742. For example, as shown in FIG. 7, when the feed stub 1742 is a T-shaped feed stub 1742, the first slot 173 is T-shaped; or as shown in FIG. 8, when the feed stub 1742 is a linear-shaped feed stub 1742, the first slot 173 is a linear-shaped feed stub 1742.

The low-frequency antenna element 130 is described below.

As shown in FIG. 7, in some embodiments, the metal layer 170 includes a ground plane 172, a radiator 171, and a short-circuit transmission line 131. A first slot 173 is disposed between the ground plane 172 and the radiator 171. The first slot 173 extends in an x direction, and the ground plane 172 and the radiator 171 are respectively on two sides of the first slot 173 in a y direction. The x direction is perpendicular to the second direction. A feed component 174 is disposed in the first slot 173. The radiator 171 is connected to a positive electrode of the feed component 174, and a positive electrode of the low-frequency antenna element 130 is located on the radiator 171. The ground plane 172 is connected to a negative electrode of the feed component 174, and a negative electrode of the low-frequency antenna element 130 is located on the ground plane 172. One end of the short-circuit transmission line 131 is connected to the positive electrode of the low-frequency antenna element 130, and the other end is connected to the negative electrode of the low-frequency antenna element 130. At least a partial structure of the short-circuit transmission line 131 is located on the ground plane 172. The y direction is an extension direction of the metal layer 170.

In an embodiment, the feed component 174 includes a feeder 1741. A positive electrode of the feeder 1741 is connected to the radiator 171, and a negative electrode of the feeder 1741 is connected to the ground plane 172. The feed component 174 is disposed to include the feeder 1741, so that a structure of the feed component 174 can be simplified, to lower costs.

In an embodiment, the feed component 174 further includes a feed stub 1742. The feed stub 1742 is located in the first slot 173, the negative electrode of the feeder 1741 is connected to the ground plane 172, the positive electrode of the feeder 1741 is connected to the feed stub 1742, and the feed stub 1742 is coupled to the radiator 171. The feed component 174 is disposed to include the feed stub 1742, so that impedance of the low-frequency antenna element 130 at 2.45 GHz can be adjusted, to ensure antenna performance at 2.45 GHz.

For example, the feed component 174 may include a feeder 1741 and a feed stub 1742, the metal layer 170 of the low-frequency antenna element 130 includes one first slot 173, one feed stub 1742 is disposed in the first slot 173, the feed stub 1742 is a T-shaped feed stub 1742, and there is a slot between the feed stub 1742 and each of the ground plane 172 and the radiating element 1712 close to the ground plane 172. A negative electrode of the feeder 1741 is connected to the ground plane 172, a positive electrode of the feeder 1741 is connected to the T-shaped feed stub 1742, and an end that is of the T-shaped feed stub 1742 and that is close to the radiating element 1712 is coupled to the radiating element 1712, so that the T-shaped feed stub 1742 feeds the radiator 171, and the radiating element 1712 close to the ground plane 172 is the positive electrode of the low-frequency antenna element 130 (as shown in FIG. 7).

As shown in FIG. 7, one end of the short-circuit transmission line 131 is connected to the radiating element 1712 close to the ground plane 172, and the other end is connected to the feeder 1741 located on the ground plane 172, in other words, the other end of the short-circuit transmission line 131 is connected to a connection point between the ground plane 172 and the feeder 1741.

In this embodiment, at least a partial structure of the short-circuit transmission line 131 is located on the ground plane 172 or the radiating element 1712 close to the ground plane 172, that is, a partial structure of the short-circuit transmission line 131 overlaps a partial structure of the ground plane 172 or the radiating element 1712 close to the ground plane 172.

For example, at least a partial structure of the short-circuit transmission line 131 is located on the ground plane 172, that is, a partial structure of the short-circuit transmission line 131 is a part of the ground plane 172. The partial structure of the short-circuit transmission line 131 and the ground plane 172 are integrally disposed, so that a size of the ground plane 172 can be reduced, thereby facilitating miniaturization development of the low-frequency antenna element 130.

In an embodiment, a length from the positive electrode of the low-frequency antenna element 130 to the negative electrode of the low-frequency antenna element 130 along an extension path of the short-circuit transmission line 131 is a wavelength corresponding to any frequency in a suppressed frequency band of the low-frequency antenna element 130. For example, the length may be a wavelength corresponding to a center frequency in the suppressed frequency band.

For ease of description, the length from the positive electrode of the low-frequency antenna element 130 to the negative electrode of the low-frequency antenna element 130 along the extension path of the short-circuit transmission line 131 is used as a length of the short-circuit transmission line 131. For example, if a resonance frequency of the low-frequency antenna element 130 is 2.45 GHz, and the suppressed frequency band of the low-frequency antenna element 130 is 5.15 GHz to 5.85 GHz, the length of the short-circuit transmission line 131 may be any value between λ_{5.15 GHz} and λ_{5.85 GHz}, for example, λ_{5.15 GHz}, λ_{5.5 GHz}, or λ_{5.85 GHz}.

Because a resonance frequency f₂ of the high-frequency antenna element 140 is in the suppressed frequency band of 5.15 GHz to 5.85 GHz of the low-frequency antenna element 130, the low-frequency antenna element 130 can suppress the resonance frequency of the high-frequency antenna element 140, thereby improving isolation between the low-frequency antenna element 130 and the high-frequency antenna element 140, reducing interference between the low-frequency antenna element 130 and the high-frequency antenna element 140, and improving operating efficiency of the antenna array. The short-circuit transmission line 131 is disposed between the ground plane 172 and the radiating element 1712 close to the ground plane 172, and the length of the short-circuit transmission line 131 is set to be equal or nearly equal to a wavelength λ_{5.5 GHz} corresponding to the resonance frequency of the high-frequency antenna element 140, so that the low-frequency antenna element 130 can suppress a 5G second harmonic.

Certainly, in another embodiment, the resonance frequency of the low-frequency antenna element 130 may alternatively be another value, for example, may be 2.4 GHz, 2.5 GHz, or 2.6 GHz. Any frequency in the suppressed frequency band of the low-frequency antenna element 130 is greater than twice the resonance frequency of the low-frequency antenna element 130. Therefore, the suppressed frequency band of 5.15 GHz to 5.85 GHz of the low-frequency antenna element 130 may be referred to as a second harmonic of the low-frequency antenna element 130. In other words, the low-frequency antenna element 130 may suppress the 5G second harmonic.

The length of the short-circuit transmission line 131 is set to be equal to the wavelength corresponding to the any frequency in the suppressed frequency band of the low-frequency antenna element 130, so that when the low-frequency antenna element 130 operates at a fundamental wave, the short-circuit transmission line 131 is equivalent to an open circuit, a bandpass is formed, and there is no impact on fundamental wave radiation; and when the low-frequency antenna element 130 operates in the suppressed frequency band, the short-circuit transmission line 131 is equivalent to a short circuit, a notch is formed, a current is confined to the short-circuit transmission line 131, and a zero is formed, to suppress an inter-frequency signal, so as to improve isolation between the low-frequency antenna element 130 and the high-frequency antenna element 140, avoid an insertion loss caused by addition of a filter, and improve operating efficiency of the low-frequency antenna element 130.

For example, the short-circuit transmission line 131 includes a first extension section 1311, a second extension section 1312, and a connection section 1313. The first extension section 1311 is located on an outer side of the second extension section 1312, and the first extension section 1311 is of a straight-line structure and extends in the y direction. The second extension section 1312 is of an L-shaped structure, a part of the second extension section 1312 extends in the y direction, and a part of the second extension section 1312 extends in the x direction. The first extension section 1311 and the part that is of the second extension section 1312 and that extends in the y direction are disposed opposite to each other, and there is a second slot 175 between the first extension section 1311 and the part that is of the second extension section 1312 and that extends in the y direction. The connection section 1313 is perpendicular to the first extension section 1311, and the connection section 1313 is located at an end that is of the second slot 175 and that is away from the radiator 171. One end of the connection section 1313 is connected to the first extension section 1311, and the other end is connected to the second extension section 1312.

As shown in FIG. 7, the short-circuit transmission line 131 is a partial structure of the ground plane 172, which is equivalent to that a second slot 175 extending in the y direction is disposed on the first sidewall 1722 of the ground plane 172. An end that is of the second slot 175 and that is close to the radiator 171 communicates with the first slot 173, and a sum of lengths of the first extension section 1311 and the second extension section 1312 is the wavelength λ_{5.5 GHz} corresponding to the resonance frequency f₂ of the high-frequency antenna element 140. Because the second slot 175 is very narrow, a length of the connection section 1313 is very small and can be ignored. A length of the second slot 175 in the y direction is ½ of the wavelength λ_{5.5 GHz} corresponding to the resonance frequency f₂ of the high-frequency antenna element 140. That is, the lengths of the first extension section 1311 and the second extension section 1312 are made equal, so that lengths of short-circuit transmission lines 131 located on two sides of the connection section 1313 can be equal. In this way, pattern performance of the antenna can be improved, and operating efficiency of the antenna can be improved.

It should be noted that a width of the second slot 175 in the x direction is small. In this embodiment of this application, the width of the second slot 175 in the x direction is not further limited.

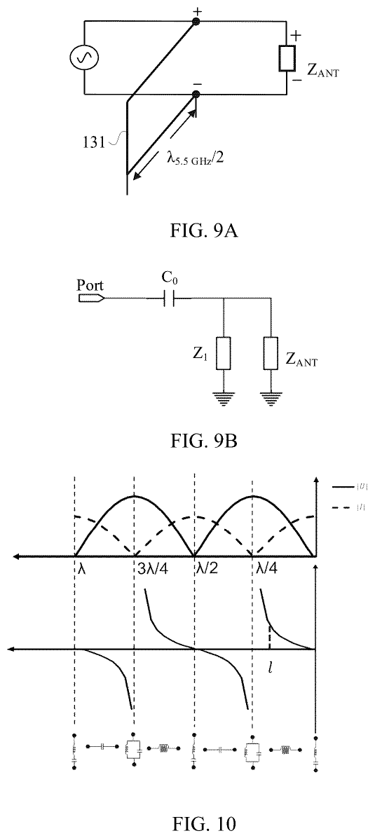

Because the positive electrode of the feeder 1741 is connected to the radiating element 1712 close to the ground plane 172, and the negative electrode of the feeder 1741 is connected to the ground plane 172, that is, one end of the short-circuit transmission line 131 is connected to the positive electrode of the feeder 1741, and the other end is connected to the negative electrode of the feeder 1741, it is equivalent to that the short-circuit transmission line 131 is connected in parallel between the positive electrode and the negative electrode of the feeder 1741. As shown in FIG. 9A, Z_{ANT} is impedance of the antenna element, and a power source is a feed source. Because the metal layer 170 of the antenna element is a conductor, and the metal layer 170 includes the ground plane 172 and the radiator 171, Z_{ANT} may be considered as impedance of the metal layer 170 of the antenna element, in other words, Z_{ANT} is port impedance between the radiator 171 and the ground plane 172.

In some embodiments, the lengths of the first extension section 1311 and the second extension section 1312 are equal, and both are λ_{5.5 GHz}/2. Because λ_{5.5 GHz}/2 is very close to λ_{2.45 GHz}/4, a harmonic suppression characteristic of the quarter-wavelength short-circuit transmission line 131 may be used to suppress a second harmonic of the antenna element.

It should be noted that for an equivalent circuit diagram of the low-frequency antenna element 130, refer to FIG. 9B in which Port is a port, namely, the feed source, C₀ is an equivalent capacitor of the feed stub 1742, Z_{ANT} is the impedance of the antenna element, Z₁ is impedance of the short-circuit transmission line 131, f₁ is the resonance frequency corresponding to the low-frequency antenna element 130, and may also be referred to as a fundamental frequency, and f is an operating frequency of the low-frequency antenna element 130, namely, a frequency input to the low-frequency antenna element 130. The impedance of the short-circuit transmission line 131 is Z₁=jZ₀ tan(βd)=jZ₀ tan(0.5*π*f/f₁), where Z₀ is characteristic impedance of the short-circuit transmission line 131.

FIG. 10 shows curves of a standing wave and an impedance characteristic of a short-circuit transmission line 131. In the figure, a horizontal axis represents a wavelength of a standing wave in the transmission line, a vertical axis represents impedance, and a bottom of the figure represents an impedance characteristic corresponding to a corresponding wavelength interval. When a wavelength corresponding to the operating frequency at which the low-frequency antenna element 130 operates is λ_{2.45 GHz}/4 or 3λ_{2.45 GHz}/4, the short-circuit transmission line 131 may be equivalent to a parallel LC loop. When a wavelength corresponding to the operating frequency at which the low-frequency antenna element 130 operates is less than λ_{2.45 GHz} and greater than 3λ_{2.45 GHz}/4 or less than λ_{2.45 GHz}/2 and greater than λ_{2.45 GHz}/4, the open-circuit transmission line is inductive. When a wavelength corresponding to the operating frequency at which the low-frequency antenna element 130 operates is λ_{2.45 GHz}/2, the short-circuit transmission line 131 has impedance of 0, and is equivalent to a series LC loop.

In a router 20 product, a Wi-Fi 2.4G antenna, namely, the low-frequency antenna element 130, needs to suppress a high-order harmonic with a frequency band range of 5.15 GHz to 5.85 GHz. To implement better harmonic suppression, a short-circuit impedance line with a length of λ_{5.5 GHz}/2 needs to be connected in parallel. Because λ_{5.5 GHz}/2 is less than λ_{2.45 GHz}/4, for the 2.4G antenna, the length of the short-circuit transmission line 131 connected in parallel is slightly shorter than a quarter wavelength, and it may be learned from the standing wave and the impedance characteristic of the short-circuit transmission line 131 in FIG. 10 that the short-circuit transmission line 131 is inductive (refer to 1 in the figure). In this embodiment, capacitive coupled feeding implemented through the T-shaped feed stub 1742 may be used to adjust impedance of the low-frequency antenna element 130 at 2.45G, so as to ensure performance of the 2.4G antenna.

The feed stub 1742 is disposed as a T-shaped structure, so that the impedance of the low-frequency antenna element 130 at 2.45G is adjusted, to ensure the performance of the 2.4G antenna and improve performance of the low-frequency antenna element 130.

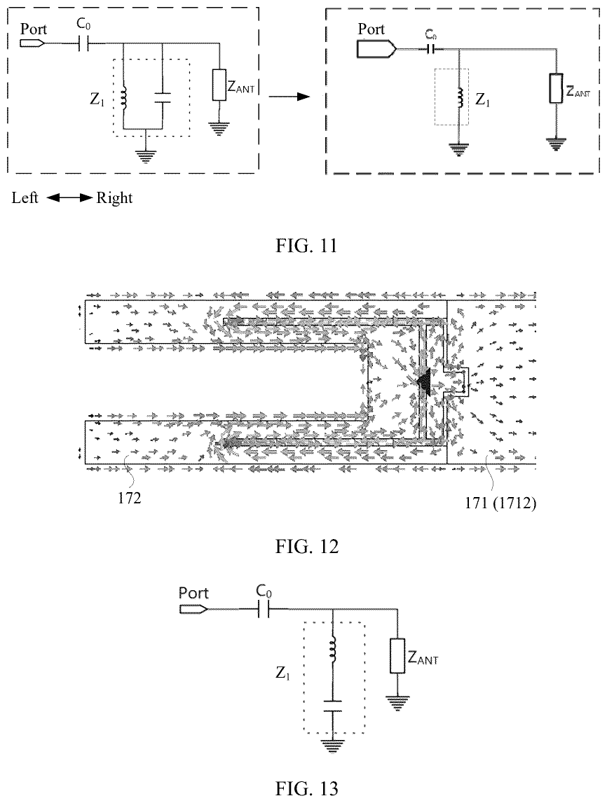

It may be learned from the foregoing formula for calculating the impedance Z₁ of the short-circuit transmission line 131 that when the fundamental wave f₁ is input to the low-frequency antenna element 130, Z₁=jZ₀ tan (0.5*π)=∞, it is equivalent to an open circuit, which is equivalent to a parallel LC loop shown on a left side in FIG. 11, a bandpass is formed, and there is no impact on fundamental wave radiation. For better harmonic suppression, the length of the short-circuit transmission line 131 is slightly shorter than λ_{2.45 GHz}/4. Therefore, an equivalent current is a parallel inductor, as shown on a right side in FIG. 11. Current distribution on the short-circuit transmission line 131 is shown in FIG. 12. A current may radiate to the radiator 171, so that the antenna can radiate an electromagnetic wave signal. As shown in FIG. 11 and FIG. 12, there is no impact on fundamental wave radiation, that is, there is no impact on operation of the low-frequency antenna element 130.

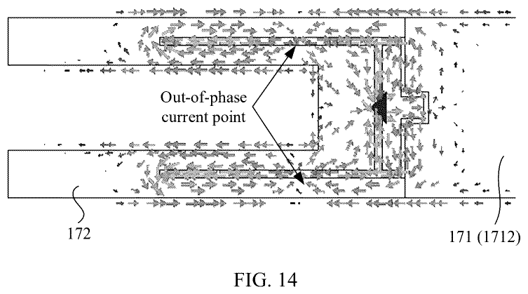

When f=2f₁, Z₁=jZ₀ tan(π)=0, and it is equivalent to a short circuit. An equivalent circuit diagram is shown in FIG. 13. A current is transmitted on the short-circuit transmission line 131, and therefore does not enter the radiator 171 of the low-frequency antenna element 130, and a notch is formed, to suppress a second harmonic. FIG. 14 is a diagram of electric field distribution on a filtering structure in which the short-circuit transmission line 131 is disposed. As shown in FIG. 14, a current is confined to the short-circuit transmission line 131, and a zero is formed, to implement second harmonic suppression.

It should be noted that because the low-frequency antenna element 130 and the high-frequency antenna element 140 are disposed adjacent to each other and have different resonance frequencies, mutual interference is generated between the low-frequency antenna element 130 and the high-frequency antenna element 140. Therefore, isolation between the low-frequency antenna element 130 and the high-frequency antenna element 140 needs to be controlled, to ensure communication quality of the array antenna.

In this embodiment, the resonance frequency f₁ of the low-frequency antenna element 130 is 2.45 GHz, and the resonance frequency f₂ of the high-frequency antenna element 140 is 5.5 GHz. For the low-frequency antenna element 130, a high-order harmonic with a frequency band range of 5.15 GHz to 5.85 GHz needs to be suppressed. Because the frequency band range of 5.15 GHz to 5.85 GHz is close to 2f₁, when the fundamental wave f₁ is input to the low-frequency antenna element 130, Z₁=jZ₀ tan (0.5*π)=∞, it is equivalent to an open circuit, and there is no impact on operation of the low-frequency antenna element 130. When f is any frequency between 5.15 GHz and 5.85 GHz, f is close to 2f₁, Z₁≈jZ₀ tan (π)≈0, in other words, the impedance is very small, and it is also equivalent to a short circuit. A current is transmitted on the short-circuit transmission line 131, and therefore does not enter the radiator 171 of the low-frequency antenna element 130, to suppress a second harmonic.

The short-circuit transmission line 131 is connected in parallel between the positive electrode and the negative electrode of the low-frequency antenna element 130, and the length of the short-circuit transmission line 131 is set to twice a half of the wavelength corresponding to the resonance frequency of the high-frequency antenna element 140, namely, 2*0.5λ_{5.5 GHz}, so that a second harmonic at a frequency close to the frequency of the high-frequency antenna element 140 can be suppressed, to improve isolation between the low-frequency antenna element 130 and the high-frequency antenna element 140, reduce interference between the low-frequency antenna element 130 and the high-frequency antenna element 140, avoid an insertion loss caused by addition of a filter, and improve operating efficiency of the antenna element.

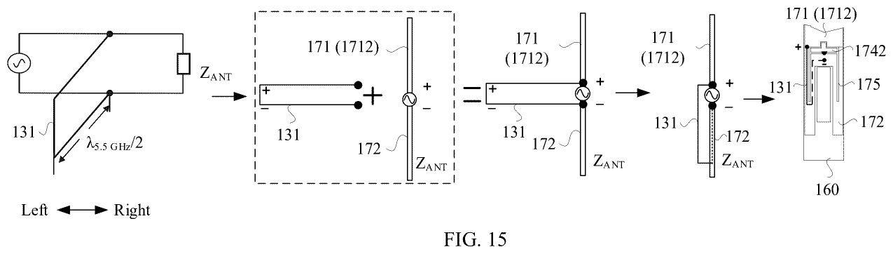

FIG. 15 is a design idea diagram of a low-frequency antenna element 130 in an antenna array according to an embodiment of this application. As shown in FIG. 15, the radiator 171 and the ground plane 172 of the low-frequency antenna element 130 are equivalent to two resistors connected to a positive electrode and a negative electrode of a power source. For example, in the figure, the radiator 171 is connected to the positive electrode, and the ground plane 172 is connected to the negative electrode. It may be learned from a fourth figure from the left in FIG. 15 that one end of the short-circuit transmission line 131 is connected to the radiator 171, and the other end is connected to the ground plane 172. To implement integration with the metal layer 170 of the low-frequency antenna element 130, a partial structure of the ground plane 172 may be disposed as a partial structure of the short-circuit transmission line 131. In this way, an increase, in a volume of the low-frequency antenna element 130, caused by introduction of a filtering structure, can be avoided, thereby facilitating miniaturization development of the antenna element.

It should be noted that in this embodiment of this application, the length of the short-circuit transmission line 131 may be 2*0.5λ_{5.5 GHz}. Certainly, in another embodiment, the length of the short-circuit transmission line 131 may alternatively be a wavelength corresponding to any frequency in the frequency band range of 5.15 GHz to 5.85 GHz that needs to be suppressed by the low-frequency antenna element 130. A specific length of the short-circuit transmission line 131 is not further limited.

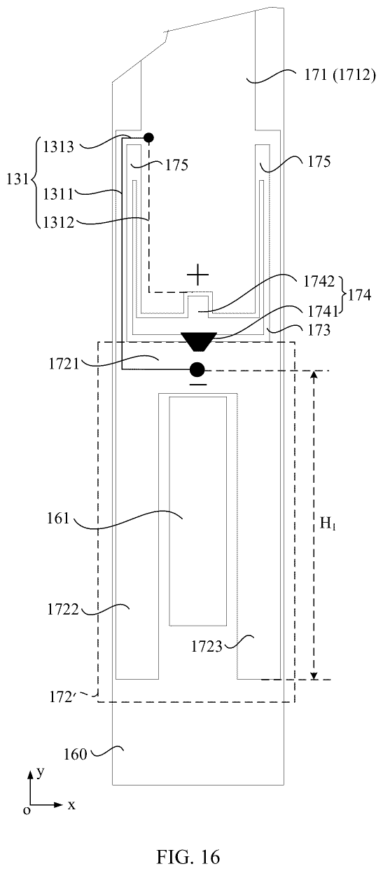

It should be noted that in this embodiment of this application, the short-circuit transmission line 131 may be integrated into the ground plane 172, that is, the short-circuit transmission line 131 is a part of the ground plane 172 (shown in FIG. 7). Certainly, in another embodiment, the short-circuit transmission line 131 may alternatively be integrated into the radiating element 1712 close to the ground plane 172, that is, the short-circuit transmission line 131 is a part of the radiating element 1712 close to the ground plane 172 (shown in FIG. 16). An equivalent circuit diagram is shown in FIG. 9B.

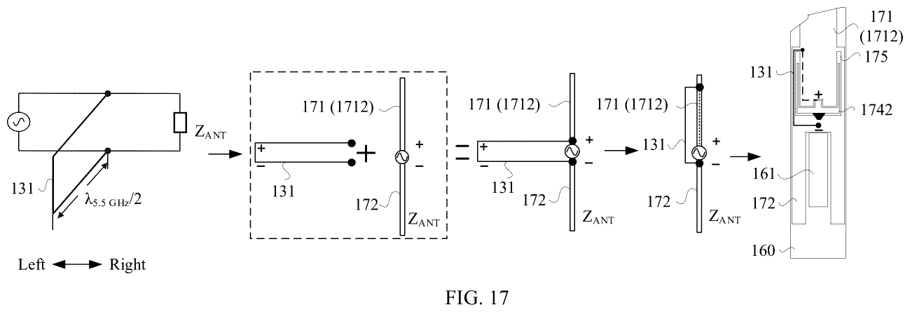

FIG. 17 is a design idea diagram of the structure shown in FIG. 16. As shown in a fourth figure from the left in FIG. 17, one end of the short-circuit transmission line 131 is connected to the ground plane 172 (the negative electrode of the low-frequency antenna element 130), the other end is connected to the radiating element 1712 (the positive electrode of the low-frequency antenna element 130) close to the ground plane 172, and a partial structure of the radiating element 1712 close to the ground plane 172 is a part of the short-circuit transmission line 131, that is, the short-circuit transmission line 131 and the radiating element 1712 close to the ground plane 172 are integrally designed.

As shown in FIG. 16, the short-circuit transmission line 131 may include a first extension section 1311, a second extension section 1312, and a connection section 1313. For example, the first extension section 1311 is of an L-shaped structure, a part of the first extension section 1311 extends in the x direction, and a part of the first extension section 1311 extends in the y direction. The second extension section 1312 is of an L-shaped structure, a part of the second extension section 1312 extends in the x direction, and a part of the second extension section 1312 extends in the y direction. A part of the first slot 173 is formed between the part that is of the first extension section 1311 and that extends in the x direction and the part that is of the second extension section 1312 and that extends in the x direction.

The first extension section 1311 is disposed as the L-shaped structure, and the second extension section 1312 is disposed as the L-shaped structure, so that lengths of the first extension section 1311 and the second extension section 1312 are more nearly equal to each other, to increase symmetry of the low-frequency antenna element 130, so as to improve pattern performance of the low-frequency antenna element 130.

In an embodiment, in the x direction, the second extension section 1312 is closer to a center position of the metal layer 170 than the first extension section 1311, that is, the first extension section 1311 is located on an outer side of the second extension section 1312. The short-circuit transmission line 131 is a partial structure of the radiator 171, the first extension section 1311 is connected to the negative electrode of the low-frequency antenna element 130, and the second extension section 1312 is connected to the positive electrode of the low-frequency antenna element 130. The first extension section 1311 extending in the x direction is a partial structure of the ground plane 172, and the second extension section 1312 extending in the x direction is a partial structure of the radiating element 1712 close to the ground plane 172.

The first extension section 1311 extending in the x direction is disposed as the partial structure of the ground plane 172, and the second extension section 1312 extending in the x direction is disposed as the partial structure of the radiator 171, so that the short-circuit transmission line 131 and the partial structure of the radiator 171 are integrated, to reduce a size of the ground plane 172, so as to reduce a size of the low-frequency antenna element 130, thereby facilitating miniaturization development of the low-frequency antenna element 130.

The first extension section 1311 and the part that is of the second extension section 1312 and that extends in the y direction are disposed opposite to each other, and there is a second slot 175 between the first extension section 1311 and the part that is of the second extension section 1312 and that extends in the y direction. An end that is of the second slot 175 and that is close to the ground plane 172 communicates with the first slot 173. The connection section 1313 is perpendicular to the first extension section 1311, and the connection section 1313 is located at an end that is of the second slot 175 and that is away from the radiator 171. A part of the first slot 173 is formed between the part that is of the first extension section 1311 and that extends in the x direction and the part that is of the second extension section 1312 and that extends in the x direction. The connection section 1313 is located at an end that is of the second slot 175 and that is away from the ground plane 172. One end of the connection section 1313 is connected to the first extension section 1311, and the other end is connected to the second extension section 1312.

In this embodiment, the low-frequency antenna element 130 may include two short-circuit transmission lines 131, and the two short-circuit transmission lines 131 are symmetrically disposed on two sides of the metal layer 170 in the x direction. The two short-circuit transmission lines 131 are disposed, and the two short-circuit transmission lines 131 are symmetrically disposed on the two sides of the metal layer 170 in the x direction, so that the ground plane 172 can be of a symmetric structure, to improve pattern performance of the low-frequency antenna element 130.

In this embodiment, the feed stub 1742 is a U-shaped feed stub 1742. The positive electrode of the feeder 1741 is connected to the feed stub 1742, the negative electrode of the feeder 1741 is connected to the ground plane 172, and the feed stub 1742 is coupled to the radiating element 1712 close to the ground plane 172. For example, a partial structure of the feed stub 1742 is located in the first slot 173, and the other partial structure of the feed stub 1742 is located in the second slot 175.

In this embodiment, the length of the short-circuit transmission line 131 is equal to the wavelength λ_{5.5 GHz} corresponding to the resonance frequency f₂ of the high-frequency antenna element 140. Because the second slot 175 is very narrow, a length of the connection section 1313 is very small and can be ignored. Therefore, a sum of lengths of the first extension section 1311 and the second extension section 1312 is the wavelength λ_{5.5 GHz} corresponding to the resonance frequency f₂ of the high-frequency antenna element 140. The short-circuit transmission line 131 with a length of 2*0.5λ_{5.5 GHz} is connected in parallel, so that a second harmonic with a frequency band range of 5.15 GHz to 5.85 GHz can be suppressed.

As shown in FIG. 16, a partial structure of the short-circuit transmission line 131 is a partial structure of the radiating element 1712 close to the ground plane 172, which is equivalent to that a second slot 175 extending in the y direction is disposed at a position that is close to an edge of the radiating element 1712 close to the ground plane 172. An end that is of the second slot 175 and that is close to the ground plane 172 communicates with the first slot 173, and a length of the second slot 175 in the y direction is λ_{5.5 GHz}/2. Certainly, in another embodiment, the length of the second slot 175 in the y direction may alternatively be another value. In this embodiment of this application, the length of the second slot 175 in the y direction is not further limited.

It should be noted that a width of the second slot 175 in the x direction is small. In this embodiment of this application, the width of the second slot 175 in the x direction is not further limited.

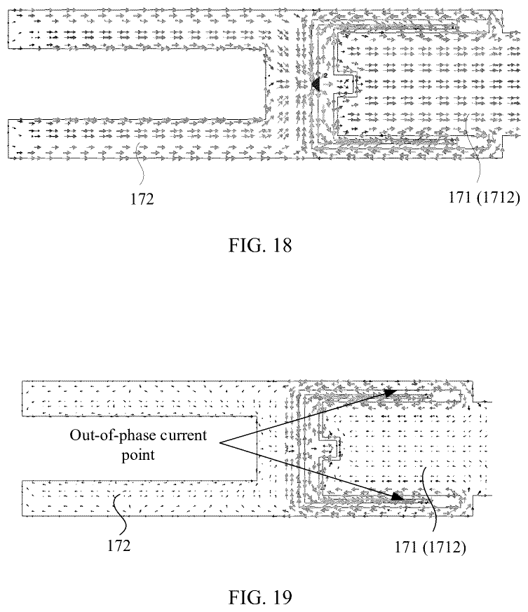

When the fundamental wave f₁ is input to the low-frequency antenna element 130, Z₁=jZ₀ tan (0.5*π)=∞, it is equivalent to an open circuit. An equivalent circuit diagram is shown in a left figure shown in FIG. 11. A bandpass is formed, and there is no impact on fundamental wave radiation. For better harmonic suppression, the length of the short-circuit transmission line 131 is slightly shorter than λ_{2.45 GHz}/4. Therefore, an equivalent current is a parallel inductor, as shown in a right figure shown in FIG. 11. Current distribution on a filtering structure in which the short-circuit transmission line 131 is connected in parallel is shown in FIG. 18. A current may radiate to the radiator 171, so that the antenna can radiate an electromagnetic wave signal. As shown in FIG. 11 and FIG. 18, there is no impact on fundamental wave radiation, that is, there is no impact on operation of the low-frequency antenna element 130.

When f=2f₁, Z₁=jZ₀ tan (π)=0, and it is equivalent to a short circuit. An equivalent circuit diagram is shown in FIG. 13. A current is transmitted on the short-circuit transmission line 131, and therefore does not enter the radiator 171 of the low-frequency antenna element 130, and a notch is formed, to suppress a second harmonic. FIG. 19 is a diagram of electric field distribution on a filtering structure in which the short-circuit transmission line 131 is connected in parallel. As shown in FIG. 19, a current is confined to the short-circuit transmission line 131, and a zero is formed, to implement second harmonic suppression.

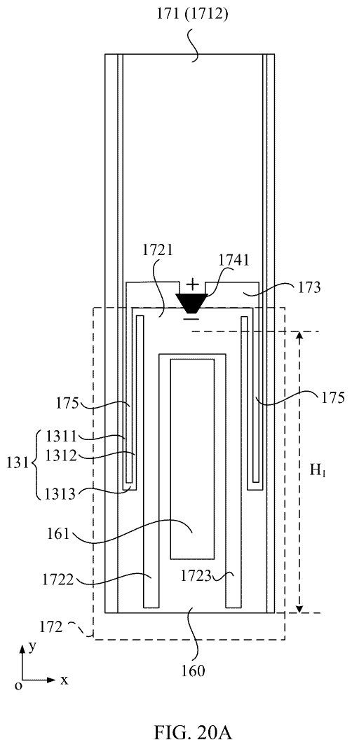

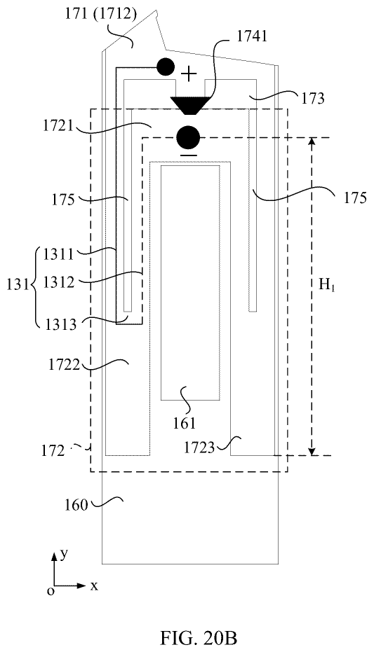

In addition, in some embodiments, the short-circuit transmission line 131 may alternatively be disposed at another position. A position at which the short-circuit transmission line 131 is disposed is not further limited in this embodiment of this application. For example, the short-circuit transmission line 131 is disposed on an outer side of the ground plane 172. As shown in FIG. 20A, one end of the first extension section 1311 is connected to the positive electrode of the low-frequency antenna element 130, one end of the first extension section 1311 is connected to the negative electrode of the low-frequency antenna element 130, the first extension section 1311 is of an L-shaped structure, a part of the first extension section 1311 extends in the x direction, and a part of the first extension section 1311 extends in the y direction. The second extension section 1312 is of an L-shaped structure, a part of the first extension section 1311 extends in the x direction, and a part of the second extension section 1312 extends in the y direction. A part of the first slot 173 is formed between the part that is of the first extension section 1311 and that extends in the x direction and the part that is of the second extension section 1312 and that extends in the x direction, and a part of the second extension section 1312 extending in the y direction is disposed at an interval from the ground plane 172. Certainly, in another embodiment, the second extension section 1312 extending in the y direction may alternatively be a partial structure of the ground plane 172 (as shown in FIG. 20B).

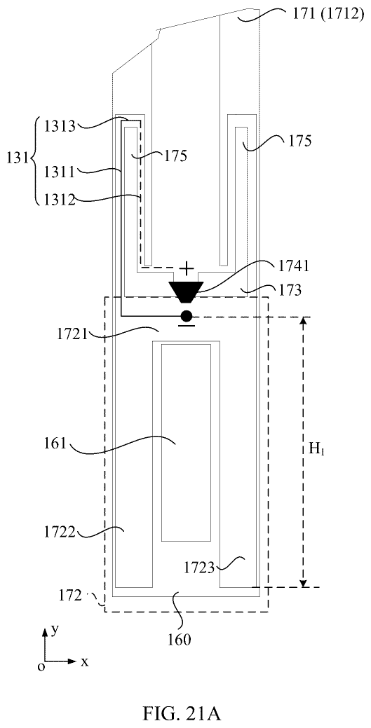

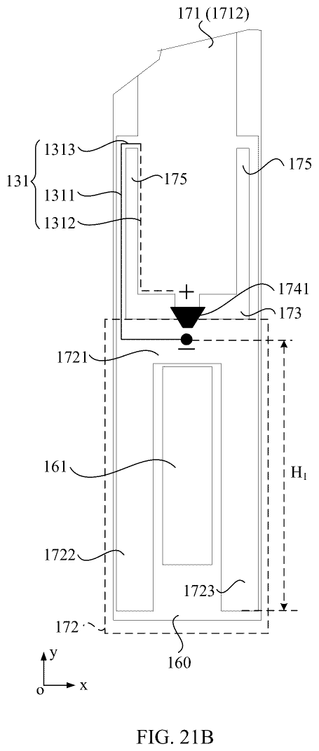

In some other embodiments, the short-circuit transmission line 131 is disposed on an outer side of the radiating element 1712 close to the ground plane 172. As shown in FIG. 21A, one end of the first extension section 1311 is connected to the negative electrode of the low-frequency antenna element 130, one end of the first extension section 1311 is connected to the positive electrode of the low-frequency antenna element 130, the first extension section 1311 is of an L-shaped structure, a part of the first extension section 1311 extends in the x direction, and a part of the first extension section 1311 extends in the y direction. The second extension section 1312 is of an L-shaped structure, a part of the first extension section 1311 extends in the x direction, and a part of the second extension section 1312 extends in the y direction. A part of the first slot 173 is formed between the part that is of the first extension section 1311 and that extends in the x direction and the part that is of the second extension section 1312 and that extends in the x direction, and a part of the second extension section 1312 extending in the y direction is disposed at an interval from the radiating element 1712. Certainly, in another embodiment, the second extension section 1312 extending in the y direction may alternatively be a partial structure of the ground plane 172 (as shown in FIG. 21B).

The first extension section 1311 extending in the x direction is disposed as the partial structure of the ground plane 172 or the radiator 171, and the second extension section 1312 extending in the x direction is disposed as the partial structure of the radiator 171 or the ground plane 172, so that the short-circuit transmission line 131 and the partial structure of the ground plane 172 are integrated, to reduce a size of the ground plane 172, so as to reduce a size of the low-frequency antenna element 130, thereby facilitating miniaturization development of the low-frequency antenna element 130.

In addition, because the lengths of the first extension section 1311 and the second extension section 1312 are equal, it is equivalent to that the short-circuit transmission line 131 between the positive electrode and the negative electrode of the feeder 1741 is symmetrically distributed. In this way, pattern performance of the antenna array can be ensured. Certainly, in some embodiments, the lengths of the first extension section 1311 and the second extension section 1312 may alternatively be set to be unequal, that is, the short-circuit transmission line 131 between the positive electrode and the negative electrode of the feeder 1741 is asymmetrically disposed (as shown in FIG. 17). A length ratio of the first extension section 1311 to the second extension section 1312 is not further limited, provided that the sum of the lengths of the first extension section 1311 and the second extension section 1312 is a wavelength corresponding to any frequency in the suppressed frequency band.

In this embodiment, there are two groups of first open-circuit transmission lines 141 and second open-circuit transmission lines 142; and the two groups of first open-circuit transmission lines 141 and second open-circuit transmission lines 142 are symmetrically disposed at two ends of the metal layer 170 in the x direction. In other words, the ground plane 172 is of a symmetric structure. In this way, impact on a pattern of the antenna array can be avoided, so that the antenna array has good pattern performance.

Certainly, in another embodiment, only one short-circuit transmission line 131 may be disposed. A quantity of short-circuit transmission lines 131 is not further limited, and a position at which the short-circuit transmission line 131 is disposed is not further limited.

Certainly, in some other embodiments, an open-circuit transmission line of λ_{5.5 GHz}/4 may be further connected in parallel in the low-frequency antenna element 130. In this way, the low-frequency antenna element 130 can be equivalent to a short circuit in the 5G frequency band, and a zero is implemented without affecting radiation in the 2.4G frequency band. Details are not further described in this embodiment.

In addition, in this embodiment of this application, the provided technical solution in which an open-circuit transmission line is connected in parallel in the low-frequency antenna element 130, so that the low-frequency antenna element 130 has a filtering function, and the provided technical solution in which an open-circuit transmission line is connected in parallel in the high-frequency antenna element 140, so that the high-frequency antenna element 140 has a filtering function may be applied to separate Wi-Fi 2.4G and 5G dipole array antennas, and the two antenna elements may be respectively arranged on two sides of a PCB dielectric board (not shown in the figure), to implement a duplex Wi-Fi filtering antenna.

A structure of the high-frequency antenna element 140 is described below.

As still shown in FIG. 8, the high-frequency antenna element 140 includes a metal layer 170 and a substrate 160. The metal layer 170 is located on a surface of the substrate 160, and the metal layer 170 includes a ground plane 172, a radiator 171, and open-circuit transmission lines. A first slot 173 is disposed between the ground plane 172 and the radiator 171. The first slot 173 extends in an x direction, and the ground plane 172 and the radiator 171 are respectively at two ends of the first slot 173 in a y direction. The x direction is perpendicular to the y direction. A feed component 174 is disposed in the first slot 173. The radiator 171 is connected to a positive electrode of the feed component 174, a positive electrode of the high-frequency antenna element 140 is located on the radiator 171, the ground plane 172 is connected to a negative electrode of the feed component 174, and a negative electrode of the high-frequency antenna element 140 is located on the ground plane 172. The open-circuit transmission lines include a first open-circuit transmission line 141 and a second open-circuit transmission line 142, and the first open-circuit transmission line 141 and the second open-circuit transmission line 142 are disposed at an interval. One end of the first open-circuit transmission line 141 is connected to one of the positive electrode or the negative electrode of the high-frequency antenna element 140, and the other end is open-circuit. One end of the second open-circuit transmission line 142 is connected to the other one of the positive electrode or the negative electrode of the high-frequency antenna element 140, and the other end is open-circuit. The y direction is an extension direction of the metal layer 170.

The first open-circuit transmission line 141 and the second open-circuit transmission line 142 are disposed at the metal layer 170, the first open-circuit transmission line 141 and the second open-circuit transmission line 142 are disposed at an interval, one end of the first open-circuit transmission line 141 is connected to one of the positive electrode or the negative electrode of the high-frequency antenna element 140, and one end of the second open-circuit transmission line 142 is connected to the other one of the positive electrode or the negative electrode of the high-frequency antenna element 140, so that one open-circuit transmission line is connected to each of the positive electrode and the negative electrode of the high-frequency antenna element 140, to suppress an inter-frequency signal of the high-frequency antenna element 140, and improve isolation between different antenna elements, so as to avoid an insertion loss caused by addition of a filter and improve operating efficiency of the high-frequency antenna element 140.

For example, a group of first open-circuit transmission lines 141 and second open-circuit transmission lines 142 is disposed on either side of the ground plane 172 in the x direction, and the ground plane 172 is of a symmetric structure. In this way, a pattern characteristic of the antenna array can be optimized. Certainly, in another embodiment, a group of first open-circuit transmission lines 141 and second open-circuit transmission lines 142 may be disposed only on one side of the ground plane 172. A quantity of first open-circuit transmission lines 141 and second open-circuit transmission lines 142 is not further limited. In addition, a structure of the ground plane 172 includes but is not limited to a symmetric structure, or may be an asymmetric structure. This may be specifically set based on a specific situation, and is not further limited in this embodiment of this application.

In some embodiments, a sum of an extension length of the first open-circuit transmission line 141 and an extension length of the second open-circuit transmission line 142 is less than or equal to a wavelength λ_{5.5 GHz} corresponding to a resonance frequency of the high-frequency antenna element 140. The resonance frequency of the high-frequency antenna element 140 is 5.5 GHz, and a suppressed frequency band of the high-frequency antenna element 140 is 2.4 GHz to 2.48 GHz.

The sum of the extension length of the first open-circuit transmission line 141 and the extension length of the second open-circuit transmission line 142 is less than or equal to the wavelength λ_{5.5 GHz} corresponding to the resonance frequency of the high-frequency antenna element 140, so that when the high-frequency antenna element 140 operates at a fundamental wave, it is equivalent to an open circuit, a bandpass structure is formed, and therefore there is no impact on fundamental wave radiation of the high-frequency antenna element 140; and when the high-frequency antenna element 140 operates in the suppressed frequency band, the first open-circuit transmission line 141 and the second open-circuit transmission line 142 are equivalent to a short circuit, a notch is formed, and a zero is implemented, to suppress an inter-frequency signal, so as to improve isolation from the low-frequency antenna element 130, remove the filter, and improve operating efficiency of the high-frequency antenna element 140.

In an embodiment, the first open-circuit transmission line 141 and the second open-circuit transmission line 142 are disposed at an interval. For example, there is a third slot 176 between the first open-circuit transmission line 141 and the second open-circuit transmission line 142, and the third slot 176 extends in the y direction. One end of the third slot 176 communicates with the first slot 173, and the other end is in an open state. That is, there is no connection relationship between the first open-circuit transmission line 141 and the second open-circuit transmission line 142.

The first open-circuit transmission line 141 and the second open-circuit transmission line 142 located on two sides of the third slot 176 may be of straight-line structures. In addition, the first open-circuit transmission line 141 may include a bent portion 143. One end of the bent portion 143 is connected to a radiating element 1712 close to the ground plane 172, and the other end is connected to the straight-line structure of the first open-circuit transmission line 141. For example, the bent portion 143 may be in a shape of an arc, an angle, or an oblique line. This may be specifically set based on a length of the first open-circuit transmission line 141, and is not further limited in this embodiment.

In an embodiment, the first open-circuit transmission line 141 is located on an outer side of the second open-circuit transmission line 142, and the second open-circuit transmission line 142 is a partial structure of the ground plane 172 or the radiator 171. The second open-circuit transmission line 142 is disposed as a part of the ground plane 172 or the radiator 171, so that the second open-circuit transmission line 142 and the ground plane 172 or the radiator 171 can be integrally designed, to reduce a size of the high-frequency antenna element 140, thereby facilitating miniaturization development of the high-frequency antenna element 140.

As shown in FIG. 8, the second open-circuit transmission line 142 is a partial structure of the ground plane 172, a partial structure of the second open-circuit transmission line 142 extends in the y direction, and the other partial structure of the second open-circuit transmission line 142 extends in the x direction. The second open-circuit transmission line 142 extends along the third slot 176 and the first slot 173, and is integrally designed with the ground plane 172, that is, the second open-circuit transmission line 142 is a partial structure of the ground plane 172. Because the first slot 173 and the third slot 176 are perpendicular to each other, the second open-circuit transmission line 142 may be of an L-shaped structure. Certainly, in another embodiment, the second open-circuit transmission line 142 may alternatively be of another structure, for example, a fold-line structure. In this embodiment, a shape of the second open-circuit transmission line 142 is not further limited.

For example, the first open-circuit transmission line 141 is located on an outer side of the ground plane 172, the second open-circuit transmission line 142 is adjacent to the first open-circuit transmission line 141, and the second open-circuit transmission line 142 is closer to a center position of the ground plane 172 than the first open-circuit transmission line 141. A sum of lengths of the first open-circuit transmission line 141 and the second open-circuit transmission line 142 may be equal to the wavelength λ_{5.5 GHz} corresponding to the resonance frequency of the high-frequency antenna element 140.

In some embodiments, the lengths of the first open-circuit transmission line 141 and the second open-circuit transmission line 142 may be equal. For example, the length of the first open-circuit transmission line 141 is λ_{5.5 GHz}/2, and the length of the second open-circuit transmission line 142 is also λ_{5.5 GHz}/2. Certainly, the lengths of the first open-circuit transmission line 141 and the second open-circuit transmission line 142 may be unequal. For example, the length of the first open-circuit transmission line 141 is 2Δ_{5.5 GHz}/3, and the length of the second open-circuit transmission line 142 is λ_{5.5 GHz}/3. In this embodiment, a length ratio of the first open-circuit transmission line 141 to the second open-circuit transmission line 142 is not further limited.

In this embodiment, a resonance frequency of the low-frequency antenna element 130 is 2.45 GHz, and the resonance frequency of the high-frequency antenna element 140 is 5.5 GHz. For the high-frequency antenna element 140, a low-frequency signal with a frequency band range of 2.4 GHz to 2.48 GHz needs to be suppressed, to ensure isolation of the antenna array.

In this embodiment, the feed component 174 includes a feeder 1741 and a feed stub 1742. The feed stub 1742 is located in the first slot 173, a negative electrode of the feeder 1741 is connected to the ground plane 172, a positive electrode of the feeder 1741 is connected to the feed stub 1742, and the feed stub 1742 is coupled to the radiator 171. For example, the feed stub 1742 may be a linear-shaped feed stub 1742. One end of the feeder 1741 is connected to the ground plane 172, the other end is connected to the feed stub 1742, and the feed stub 1742 is coupled to the radiating element 1712. One end of the first open-circuit transmission line 141 is connected to the radiator 171, and the other end extends in the y direction.

The feed component 174 is disposed to include the feed stub 1742, so that impedance of the high-frequency antenna element 140 at 5.5 GHz can be adjusted, to ensure antenna performance at 5.5 GHz.

In another embodiment, the feed stub 1742 is a linear-shaped feed stub 1742, a T-shaped feed stub 1742, a U-shaped feed stub 1742, or a special-shaped feed stub 1742. A shape of the feed stub 1742 is not further limited.

The first open-circuit transmission line 141 and the second open-circuit transmission line 142 are disposed at the metal layer 170, so that a low-frequency signal with a frequency band range of 2.4 GHz to 2.48 GHz can be suppressed, to avoid signal interference between the low-frequency antenna element 130 and the high-frequency antenna element 140, and improve operating efficiency of the antenna array. For ease of description, both the first open-circuit transmission line 141 and the second open-circuit transmission line 142 may be referred to as open-circuit transmission lines.

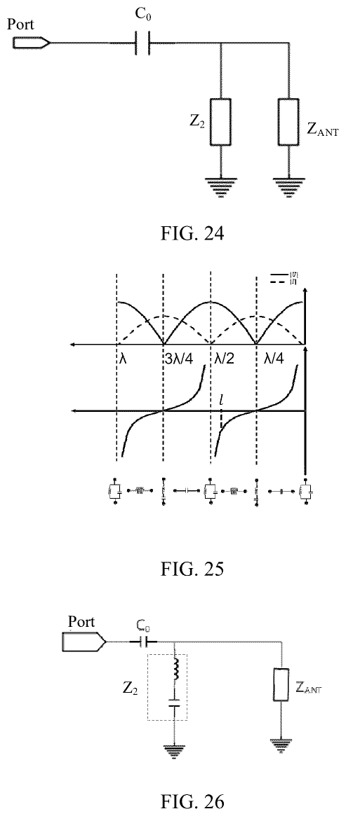

FIG. 22 is a circuit diagram in which a metal layer 170 of a low-frequency antenna element 130 in an antenna array is connected in parallel to an open-circuit transmission line according to an embodiment of this application. It should be noted that Z_{ANT} is impedance of the high-frequency antenna element 140, and a power source is a feed source. Because the metal layer 170 of the antenna element is a conductor, and the metal layer 170 includes the ground plane 172 and the radiator 171, Z_{ANT} may be considered as impedance of the metal layer 170 of the antenna element, and Z_{ANT} includes impedance of the radiator 171 and impedance of the ground plane 172. As shown in FIG. 24, two open-circuit transmission lines with an equal length, namely, a first open-circuit transmission line 141 and a second open-circuit transmission line 142, are connected in parallel between the power source and the metal layer 170. Lengths of the first open-circuit transmission line 141 and the second open-circuit transmission line 142 are equal and both are λ_{5.5 GHz}/2.

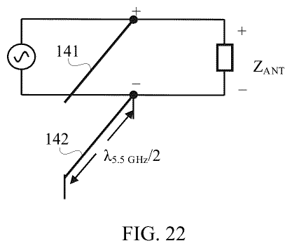

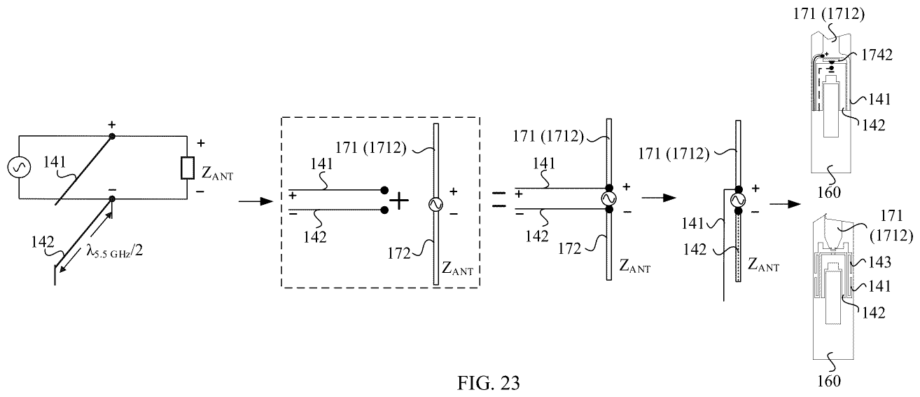

FIG. 23 is a design idea diagram of a high-frequency antenna element 140 in an antenna array according to an embodiment of this application. As shown in FIG. 23, the radiator 171 and the ground plane 172 of the high-frequency antenna element 140 are equivalent to two resistors connected to a positive electrode and a negative electrode of a power source. For example, in the figure, the radiator 171 is connected to the positive electrode, and the ground plane 172 is connected to the negative electrode. One end of the first open-circuit transmission line 141 is connected to the radiating element 1712 (the positive electrode of the high-frequency antenna element 140) close to the ground plane 172, and the other end is open-circuit. One end of the second open-circuit transmission line 142 is connected to the ground plane 172 (the negative electrode of the high-frequency antenna element 140), and the other end is open-circuit. Then, the first open-circuit transmission line 141 and the second open-circuit transmission line 142 may be integrally designed with the ground plane 172 or the radiating element 1712 close to the ground plane 172. It may be learned from a fourth figure from the left in FIG. 23 that one end of the first open-circuit transmission line 141 may be connected to the radiating element 1712, the other end may extend toward the ground plane 172, and the second open-circuit transmission line 142 may be integrated into the ground plane 172.

When the first open-circuit transmission line 141 and the second open-circuit transmission line 142 are integrated into the ground plane 172 of the high-frequency antenna element 140, due to a limitation of a length of the ground plane 172, the first open-circuit transmission line 141 and the second open-circuit transmission line 142 may be designed to be of an equal structure, that is, both the first open-circuit transmission line 141 and the second open-circuit transmission line 142 are λ_{5.5 GHz}/2, as shown in FIG. 8.

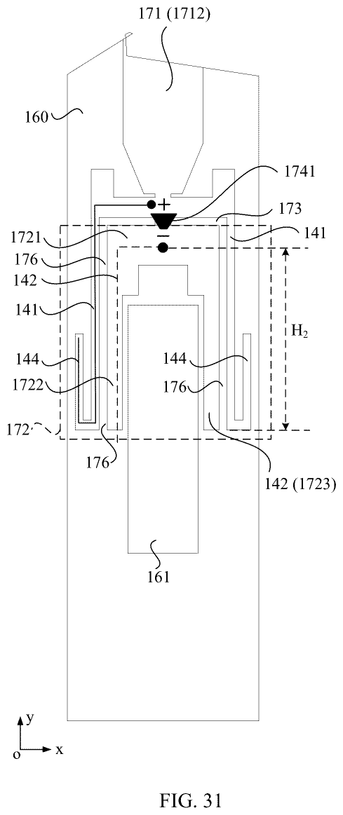

Certainly, in some other embodiments, the lengths of the first open-circuit transmission line 141 and the second open-circuit transmission line 142 may be set to be unequal. For example, the first open-circuit transmission line 141 located on the outer side may be disposed to be slightly longer, the first open-circuit transmission line 141 may be folded, and the second open-circuit transmission line 142 located on an inner side may be disposed to be slightly shorter (shown in FIG. 31). In this way, the length of the ground plane 172 of the high-frequency antenna element 140 may be set to be short, to facilitate miniaturization development of the antenna, and avoid an increase in a size of the antenna and impact on a pattern.

It should be noted that impedance of the open-circuit transmission line is Z₂=−jZ₀₁ cot (βd)=−jZ₀₁ tan (0.5*2π*f/f₂), where Z₀₁ is characteristic impedance of the open-circuit transmission line, f₂ is the resonance frequency corresponding to the high-frequency antenna element 140, and may also be referred to as a fundamental frequency, and f is an operating frequency of the high-frequency antenna element 140, namely, a frequency input to the high-frequency antenna element 140. For an equivalent circuit diagram of the high-frequency antenna element 140, refer to FIG. 24 in which C₀ is an equivalent capacitor of the feed stub 1742.

FIG. 25 shows curves of a standing wave and an impedance characteristic of an open-circuit transmission line. When a wavelength corresponding to the operating frequency at which the high-frequency antenna element 140 operates is λ_{5.5 GHz}/2 or λ_{5.5 GHz}, the open-circuit transmission line may be equivalent to a parallel LC loop. When a wavelength corresponding to the operating frequency at which the high-frequency antenna element 140 operates is less than λ_{5.5 GHz} and greater than 3λ_{5.5 GHz}/4 or less than λ_{5.5 GHz}/2 and greater than λ_{5.5 GHz}/4, the open-circuit transmission line is inductive.

In a router 20 product, a Wi-Fi 5G antenna, namely, the high-frequency antenna element 140, needs to suppress a low-frequency signal with a frequency band range of 2.4 GHz to 2.48 GHz. In some embodiments, to reduce impact of the ground plane 172 on radiation of the antenna array and ensure pattern performance of the antenna array, a length of the open-circuit transmission line connected in parallel needs to be shorter than λ_{5.5 GHz}/2, so that the antenna array generates a zero at approximately 2.9 GHz on a right side of 2.4 GHz. It may be learned from the standing wave and the impedance characteristic of the open-circuit transmission line in FIG. 25 that the impedance curve is inductive (refer to 1 in the figure). Therefore, capacitive coupled feeding implemented through the linear-shaped feed stub 1742 may be used, so that impedance in the 5G frequency band can be adjusted, to ensure impedance bandwidth of the 5G antenna and ensure operating efficiency of the antenna array.

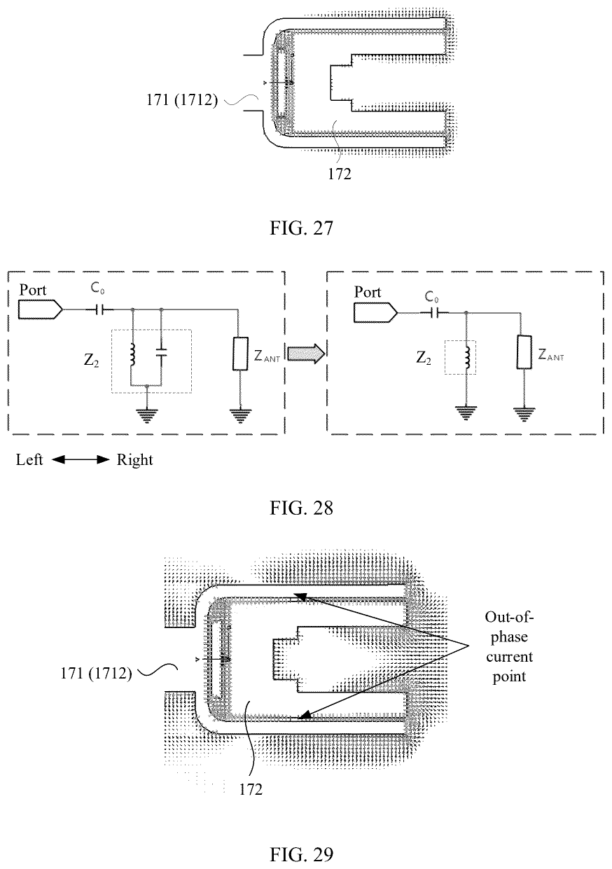

In this embodiment, it may be learned from the formula for calculating the impedance Z₂ of the open-circuit transmission line that when the high-frequency antenna element 140 operates at a half of the frequency, that is, when f=f_{2/2}, Z₂=jZ₀₁ cot (π/2)=0, it is equivalent to a short circuit, and the open-circuit transmission line may be equivalent to a series LC loop. An equivalent circuit diagram is shown in FIG. 26. A current is transmitted on the open-circuit transmission line, and therefore does not enter the radiator 171 of the high-frequency antenna element 140, a notch is formed, and a zero is implemented, to suppress an inter-frequency signal. FIG. 27 is a diagram of electric field distribution on a filtering structure. An open-circuit transmission line of a quarter wavelength (2λ_{2.45 GHz}/4) in the suppressed frequency band is connected in parallel, and it is equivalent to a short circuit at a feed point. In addition, current distribution is shown in FIG. 52. A current is confined to the open-circuit transmission line, so that there is no current on the radiator 171, and a zero is formed, to implement inter-frequency signal suppression. That is, the first open-circuit transmission line 141 and the second open-circuit transmission line 142 with a total length of 2*0.5λ_{5.5 GHz} are disposed at the metal layer 170, so that a resonance frequency with a frequency range near f_{2/2} can be suppressed, for example, a low-frequency signal with a frequency range of 2.4 GHz to 2.48 GHz can be suppressed.

When the fundamental wave f₂ is input to the high-frequency antenna element 140, Z₂=−jZ₀₁ cot (π)=−∞, it is equivalent to an open circuit, the open-circuit transmission line may be equivalent to a parallel LC loop on a left side in FIG. 28, and a bandpass structure is formed. In some embodiments, to reduce impact of the ground plane 172 on radiation of the antenna array and ensure pattern performance of the antenna array, a length of the open-circuit transmission line connected in parallel needs to be shorter than λ_{5.5 GHz}/2. An equivalent circuit diagram is shown on a right side in FIG. 28. Electric field distribution is shown in FIG. 29. The open-circuit transmission line is an open-circuit transmission line of λ_{5.5 GHz}/2, and is equivalent to an open circuit, and there is no impact on fundamental wave radiation, that is, there is no impact on operation of the high-frequency antenna element 140. Therefore, disposing of the first open-circuit transmission line 141 and the second open-circuit transmission line 142 does not affect radiation when the high-frequency antenna element 140 operates at the fundamental wave. Herein, cot (π/2)=0, and cot (π)=−∞.

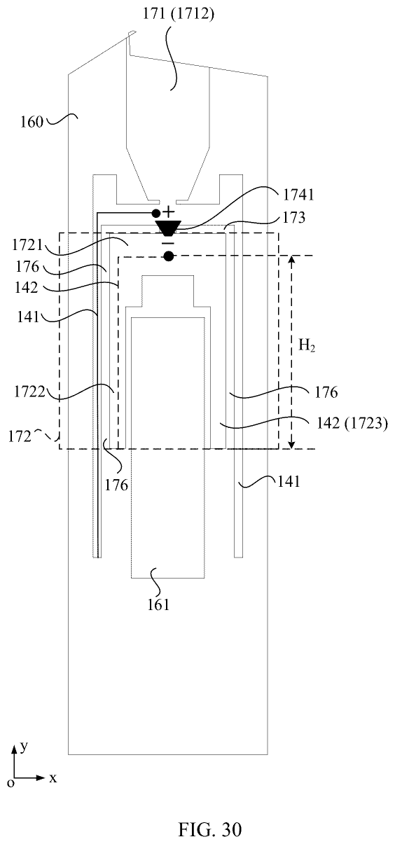

It should be noted that because the length H₂ of the ground plane 172 of the high-frequency antenna element 140 is λ_{5.5 GHz}/4, and the second open-circuit transmission line 142 is a partial structure of the ground plane 172, the length of the second open-circuit transmission line 142 located on the ground plane 172 may be set to be less than the length of the first open-circuit transmission line 141. As shown in FIG. 30, the first open-circuit transmission line 141 is of an L-shaped structure. A partial structure of the first open-circuit transmission line 141 extends in the x direction, and the other partial structure of the first open-circuit transmission line 141 extends in the y direction. One end of the first open-circuit transmission line 141 extending in the x direction is connected to the radiator 171, and the other end is connected to the first open-circuit transmission line 141 extending in the y direction. The other end of the first open-circuit transmission line 141 extending in the y direction extends in the y direction away from the radiator 171, and the first open-circuit transmission line 141 may extend in the y direction to an outer side of a first end of the ground plane 172, that is, extend out of the first end of the ground plane 172. The second open-circuit transmission line 142 is of an L-shaped structure, a partial structure of the second open-circuit transmission line 142 extends in the x direction, and the other partial structure of the second open-circuit transmission line 142 extends in the y direction. One end of the second open-circuit transmission line 142 extending in the x direction is connected to the negative electrode of the high-frequency antenna element 140, and the other end is connected to the second open-circuit transmission line 142 extending in the y direction. Certainly, in another embodiment, the first open-circuit transmission line 141 may alternatively be in another shape.

As shown in FIG. 31, the first open-circuit transmission line 141 may further include an extension portion 144. For example, the extension portion 144 may be L-shaped. A partial structure of the extension portion 144 extends in the y direction, and the other partial structure extends in the x direction. The extension portion 144 is disposed on a side that is of the first open-circuit transmission line 141 and that is away from a center position of the ground plane 172, a free end of the extension portion 144 extending in the x direction is connected to an end that is of the first open-circuit transmission line 141 and that is away from the first slot 173, and a part that is of the extension portion 144 and that extends in the y direction and a part that is of the first open-circuit transmission line 141 and that is opposite to the second open-circuit transmission line 142 are disposed at an interval.

That is, the extension portion 144 is folded from the first end of the ground plane 172 to the outer side of the ground plane 172, and then extends in the y direction toward a second end of the ground plane 172, to extend the length of the first open-circuit transmission line 141, so that the sum of the lengths of the first open-circuit transmission line 141 and the second open-circuit transmission line 142 can be λ_{5.5 GHz}.

The extension portion 144 is disposed, so that the length of the first open-circuit transmission line 141 can be extended, and therefore the length of the second short-circuit transmission line 131 can be reduced, to reduce a length of the ground plane 172 in the y direction, so as to reduce a volume of the high-frequency antenna element 140, thereby facilitating miniaturization development of the high-frequency antenna element 140. In addition, the extension portion 144 is disposed, so that design flexibility of the first open-circuit transmission line 141 and the second open-circuit transmission line 142 can be improved. In this way, first open-circuit transmission lines 141 and second open-circuit transmission lines 142 with different lengths can be designed based on different suppressed frequency bands, thereby improving adaptability of the high-frequency antenna element 140.

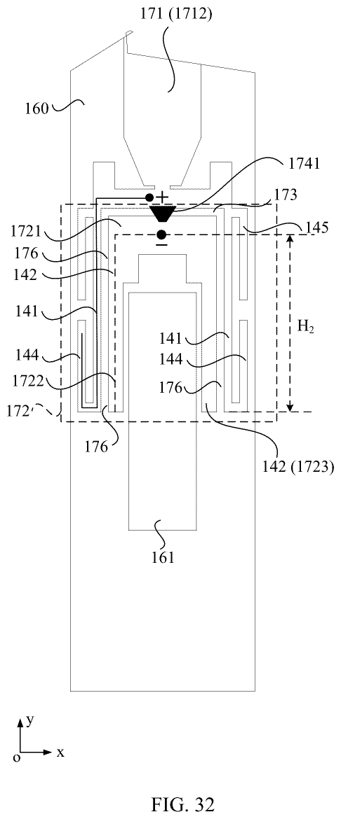

In some other embodiments, as shown in FIG. 32, a matching stub 145 may be further disposed on the first open-circuit transmission line 141. For example, the matching stub 145 may be an L-shaped matching stub 145. One end of the L-shaped matching stub 145 is connected to the first open-circuit transmission line 141, and the other end extends in the y direction. For example, one end of the L-shaped matching stub 145 is connected to the first open-circuit transmission line 141, and the other end extends in the y direction toward the extension portion 144. The matching stub 145 is disposed, so that an impedance characteristic of the first open-circuit transmission line 141 can be increased, to adjust a radiation frequency band of the high-frequency antenna element 140. In addition, the matching stub 145 is added, so that the first open-circuit transmission line 141 can be made more similar to a symmetric structure, to improve pattern performance of the high-frequency antenna element 140.

Feeding manners of the structures shown in FIG. 30 to FIG. 32 are direct feeding implemented through the feeder 1741. For example, the positive electrode of the feeder 1741 is connected to the radiator 171, and the negative electrode of the feeder 1741 is connected to the ground plane 172.

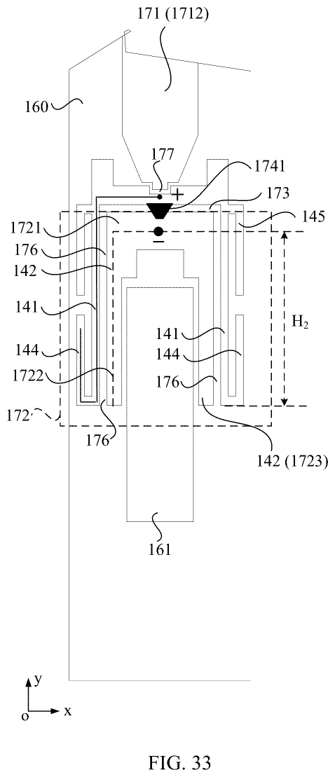

To meet an impedance characteristic of the low-frequency antenna element 130, as shown in FIG. 33, a feeding manner of the high-frequency antenna element 140 may be set to capacitive coupled feeding. For example, the feed component 174 may include a feeder 1741. A negative electrode of the feeder 1741 is connected to the ground plane 172, a positive electrode of the feeder 1741 is connected to the first open-circuit transmission line 141 extending in the x direction, the part that is of the first open-circuit transmission line 141 and that extends in the x direction is located in the first slot 173, and there is a coupling slot 177 between a partial structure that is of the first open-circuit transmission line 141 and that extends in the x direction and the radiator 171, so that the first open-circuit transmission line 141 can be coupled to the radiator 171. That is, the high-frequency antenna element 140 implements coupled feeding, briefly referred to as slot coupled feeding below, through the coupling slot 177.

It should be noted that a partial structure of the first open-circuit transmission line 141 extending in the x direction may be used as a feed stub. In this embodiment, it may be considered that the first open-circuit transmission line 141 is connected to the feed stub. A manner of forming the feed stub and the first open-circuit transmission line 141 is not further limited.

The second open-circuit transmission line 142 is a partial structure of the ground plane 172, a partial structure of the second open-circuit transmission line 142 extends in the y direction, and the other partial structure of the second open-circuit transmission line 142 extends in the x direction. The first open-circuit transmission line 141 and the second open-circuit transmission line 142 are disposed at an interval. For example, there is a third slot 176 between the first open-circuit transmission line 141 and the second open-circuit transmission line 142, and the third slot 176 extends in the y direction. One end of the third slot 176 communicates with the first slot 173, and the other end is in an open state. That is, there is no connection relationship between the first open-circuit transmission line 141 and the second open-circuit transmission line 142.

The second open-circuit transmission line 142 is a partial structure of the ground plane 172, a partial structure of the second open-circuit transmission line 142 extends in the y direction, and the other partial structure of the second open-circuit transmission line 142 extends in the x direction. The second open-circuit transmission line 142 extends along the third slot 176 and the first slot 173, and is integrally designed with the ground plane 172, that is, the second open-circuit transmission line 142 is a partial structure of the ground plane 172. Because the first slot 173 and the third slot 176 are perpendicular to each other, the second open-circuit transmission line 142 may be of an L-shaped structure. Certainly, in another embodiment, the second open-circuit transmission line 142 may alternatively be of another structure, for example, a fold-line structure. In this embodiment, a shape of the second open-circuit transmission line 142 is not further limited.

As shown in FIG. 33, a partial structure of the L-shaped extension portion 144 extends in the y direction, and the other partial structure extends in the x direction. The extension portion 144 is disposed on a side that is of the first open-circuit transmission line 141 and that is away from a center position of the ground plane 172, and a part that is of the extension portion 144 and that extends in the y direction and a part that is of the first open-circuit transmission line 141 and that is opposite to the second open-circuit transmission line 142 are disposed at an interval. A part that is of the extension portion 144 and that extends in the x direction is disposed at a first end of the ground plane 172, and is connected to the part that is of the first open-circuit transmission line 141 and that is opposite to the second open-circuit transmission line 142.

That is, the extension portion 144 is folded from the first end of the ground plane 172 to the outer side of the ground plane 172, and then extends in the y direction toward a second end of the ground plane 172, to extend the length of the first open-circuit transmission line 141, so that the sum of the lengths of the first open-circuit transmission line 141 and the second open-circuit transmission line 142 can be λ_{5.5 GHz}. In addition, a volume of the high-frequency antenna element 140 can be reduced, thereby facilitating miniaturization development of the antenna array.

One end of the L-shaped matching stub 145 is connected to the first open-circuit transmission line 141, and the other end extends in the y direction. For example, one end of the L-shaped matching stub 145 is connected to the first open-circuit transmission line 141, and the other end extends in the y direction toward the extension portion 144. In this way, the first open-circuit transmission line 141 can be of a symmetric structure, to improve pattern performance of the antenna array.

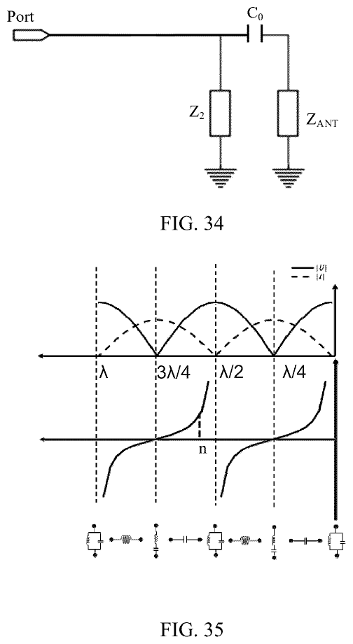

It should be noted that line widths of the first open-circuit transmission line 141 and the second open-circuit transmission line 142 are less than a width of the radiating element 1712 in the x direction, and the lengths are λ_{2.45 GHz}/4. As shown in FIG. 34, Z_{ANT} is impedance of the high-frequency antenna element 140, C₀ is an equivalent capacitor of the feed stub 1742, f₂ is the resonance frequency corresponding to the high-frequency antenna element 140, and may also be referred to as a fundamental frequency, Z₀₁ is characteristic impedance of the open-circuit transmission line, and impedance of the open-circuit transmission line is Z₂=−jZ₀₁ cot (βd)=−jZ₀₁ tan (0.5*2π*f/f₂).

In addition, in a router 20 product, a Wi-Fi 5G antenna needs to suppress a low-frequency signal with a frequency band range of 2.4 GHz to 2.48 GHz. To further improve isolation between different antenna elements in the antenna array, the length of the first open-circuit transmission line 141 or the second open-circuit transmission line 142 connected in parallel (in a case in which the lengths of the first open-circuit transmission line 141 and the second open-circuit transmission line 142 are equal) is approximately λ_{2.45 GHz}/4, and is slightly longer than λ_{5.5 GHz}/2, that is, the sum of the lengths of the first open-circuit transmission line 141 and the second open-circuit transmission line 142 is approximately λ_{2.45 GHz}/2, and is slightly longer than λ_{5.5 GHz}. It may be learned from the standing wave and the impedance characteristic of the open-circuit transmission line shown in FIG. 35 that the impedance curve is capacitive (at a marked point n in the figure). Therefore, an L-shaped matching stub 145 is added, to add an inductive component, so that impedance in a 5G frequency band can be adjusted.

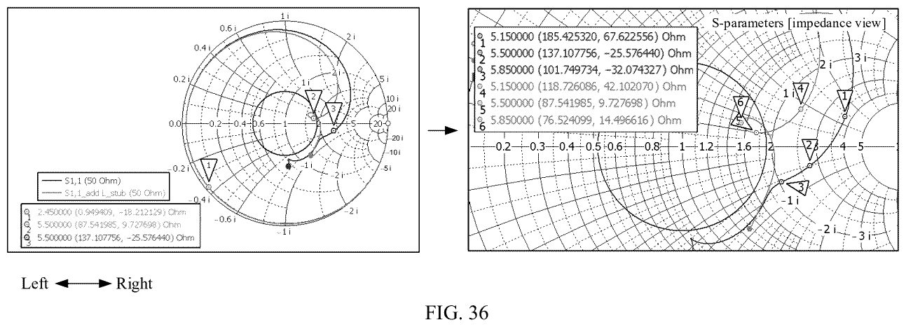

As shown in FIG. 36, a left figure shows an S-parameter Smith chart in a case in which no L-shaped matching stub 145 is added, and a right figure shows an S-parameter Smith chart in a case in which an L-shaped matching stub 145 is added. A marked point 1 represents impedance at 2.45 GHz, and impedance at the marked point 1 is very small and almost 0. Therefore, the filtering structure implements a transmission zero at 2.45 GHz. It may be learned, through comparison between the left and right figures in FIG. 36, that after the L-shaped matching stub 145 is loaded, impedance of the open-circuit transmission line moves from a capacitive region to an inductive region, and the curve is more converged to a −10 dB reflection circle. Capacitive coupled feeding implemented through the linear-shaped feed stub 1742 is further used to introduce a capacitive component, so as to implement broadband.

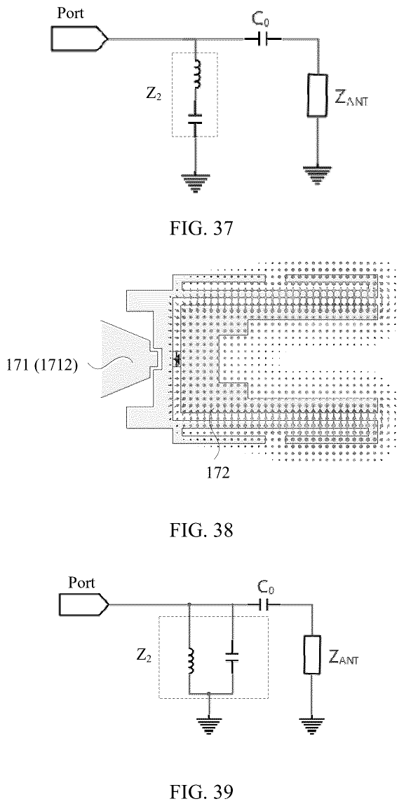

It may be learned from the formula for calculating the impedance Z₂ of the open-circuit transmission line that when the high-frequency antenna element 140 operates at a half of the frequency, that is, when f=f₂/2, Z₂−jZ₀₁ cot (π/2)=0, it is equivalent to a short circuit, and the open-circuit transmission line may be equivalent to a series LC loop. An equivalent circuit diagram is shown in FIG. 37. A current is transmitted on the open-circuit transmission line, and therefore does not enter the radiator 171 of the high-frequency antenna element 140, a notch is formed, and a zero is implemented, to suppress an inter-frequency signal. FIG. 38 is a diagram of electric field distribution on the ground plane 172. As shown in FIG. 38, at 2.45 GHz, the transmission line is a quarter-wavelength open-circuit transmission line, and therefore is equivalent to a short circuit at a feed point, and a zero is formed, to implement inter-frequency signal suppression. That is, the first open-circuit transmission line 141 and the second open-circuit transmission line 142 are disposed, so that a resonance frequency with a frequency range near f₂/2 can be suppressed, for example, a low-frequency signal with a frequency range of 2.4 GHz to 2.48 GHz can be suppressed.

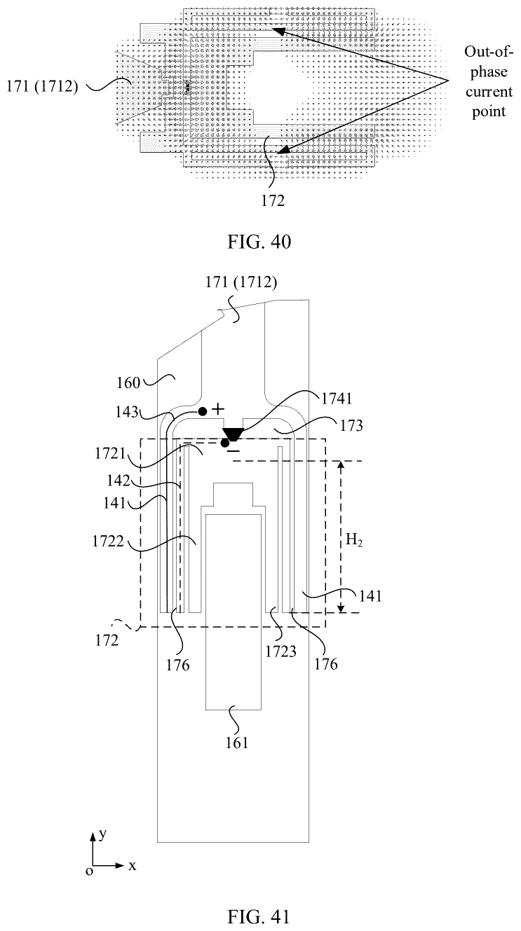

When the fundamental wave f₂ is input to the high-frequency antenna element 140, Z₂=−jZ₀₁ cot (π)=−∞, it is equivalent to an open circuit, the first open-circuit transmission line 141 and the second open-circuit transmission line 142 may be equivalent to a parallel LC loop in FIG. 39, and a bandpass structure is formed. Based on the foregoing analysis, the open-circuit transmission line is capacitive (as marked by n in FIG. 35), and capacitance of the slot feed stub 1742 is C₀. Electric field distribution is shown in FIG. 40. There is no impact on transmission of the antenna, that is, there is no impact on operation of the high-frequency antenna element 140. That is, disposing of the first open-circuit transmission line 141 and the second open-circuit transmission line 142 does not affect radiation when the high-frequency antenna element 140 operates at the fundamental wave.

In some other embodiments, as shown in FIG. 41, the first open-circuit transmission line 141 and the second open-circuit transmission line 142 may alternatively be disposed on an outer side of the ground plane 172. For example, the first open-circuit transmission line 141 and the second open-circuit transmission line 142 are disposed at an interval. For example, there is a third slot 176 between the first open-circuit transmission line 141 and the second open-circuit transmission line 142, and the third slot 176 extends in the y direction. One end of the third slot 176 communicates with the first slot 173, and the other end is in an open state. That is, there is no connection relationship between the first open-circuit transmission line 141 and the second open-circuit transmission line 142.

The first open-circuit transmission line 141 and the second open-circuit transmission line 142 located on two sides of the third slot 176 may be of straight-line structures. In addition, a structure of the first open-circuit transmission line 141 is the same as the structure in FIG. 8. Details are not described herein again.

As shown in FIG. 41, a partial structure of the second open-circuit transmission line 142 extends in the y direction, and the other partial structure of the second open-circuit transmission line 142 extends in the x direction. The second open-circuit transmission line 142 extends along the third slot 176 and the first slot 173, and there is a fourth slot between the partial structure that is of the second open-circuit transmission line 142 and that extends in the y direction and the ground plane 172, that is, the second open-circuit transmission line 142 and a partial structure of the ground plane 172 are disposed at an interval. Because the first slot 173 and the third slot 176 are perpendicular to each other, the second open-circuit transmission line 142 may be of an L-shaped structure. Certainly, in another embodiment, the second open-circuit transmission line 142 may alternatively be of another structure, for example, a fold-line structure. In this embodiment, a shape of the second open-circuit transmission line 142 is not further limited.

It should be noted that the first open-circuit transmission line 141 and the second open-circuit transmission line 142 may alternatively be integrally designed with the radiator 171, and capacitive feeding may be used, or capacitance for feeding coupling may be adjusted by adjusting a shape, a thickness, or the like of the first open-circuit transmission line 141 and the second open-circuit transmission line 142.

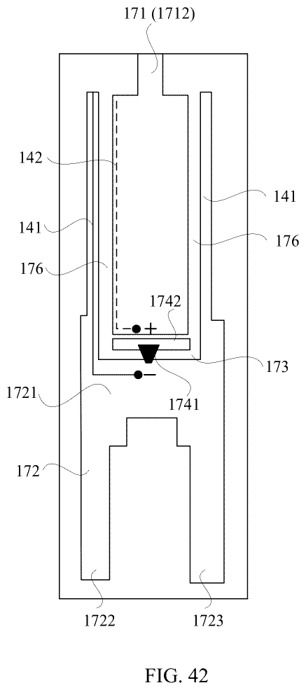

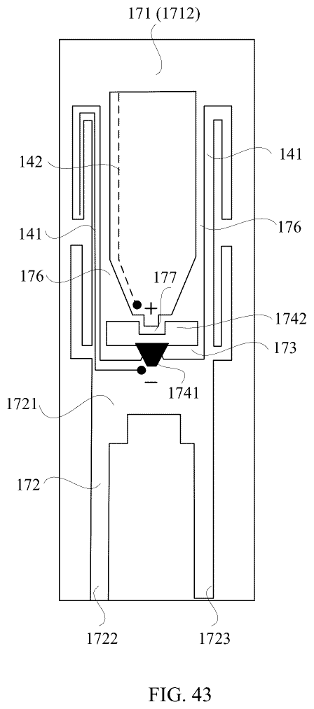

As shown in FIG. 42 and FIG. 43, the first open-circuit transmission line 141 and the second open-circuit transmission line 142 may alternatively be disposed on the radiating element 1712 close to the ground plane 172. As shown in FIG. 42, one end of the first open-circuit transmission line 141 is connected to the ground plane 172, the other end extends in the y direction away from the ground plane 172, the second open-circuit transmission line 142 and the first open-circuit transmission line 141 are disposed opposite to each other, there is a third slot 176 between the first open-circuit transmission line 141 and the second open-circuit transmission line 142, an end that is of the third slot 176 and that is close to the ground plane 172 communicates with the first slot 173, and the second open-circuit transmission line 142 is a partial structure of the radiating element 1712 close to the ground plane 172.

For example, a feed stub 1742 is disposed in the first slot 173. The positive electrode of the feeder 1741 is connected to the feed stub 1742, the feed stub 1742 is coupled to the radiating element 1712, and a negative electrode of the feed stub 1742 is connected to the ground plane 172. When a current is applied to the feeder 1741, the current is transmitted between the positive electrode and the negative electrode of the feeder 1741 along the first open-circuit transmission line 141 and the second open-circuit transmission line 142. This may be considered as that the current is transmitted along the first slot 173 and the third slot 176.

A length of the first open-circuit transmission line 141 is a length (refer to a solid line on the first open-circuit transmission line 141 in the figure) from an end that is of the first open-circuit transmission line 141 and that is away from the ground plane 172 to the negative electrode of the feeder 1741, and a length of the second open-circuit transmission line 142 is a length (refer to a dashed line on the second open-circuit transmission line 142 in the figure) from an end that is of the first transmission line and that is away from the ground plane 172 to the positive electrode of the feeder 1741 along edges of the first slot 173 and the third slot 176.

Certainly, in another embodiment, as shown in FIG. 43, an extension portion 144 may be disposed at the end that is of the first open-circuit transmission line 141 and that is away from the ground plane 172, and a matching stub 145 may be disposed at an end that is of the first open-circuit transmission line 141 and that is close to the ground plane 172. Both the extension portion 144 and the matching stub 145 may be L-shaped, and the extension portion 144 and the matching stub 145 are symmetrically disposed at two ends of a part that is of the first open-circuit transmission line 141 and that extends in the y direction. In this way, the first open-circuit transmission line 141 can be of a symmetric structure, thereby improving pattern performance of the high-frequency antenna element 140.

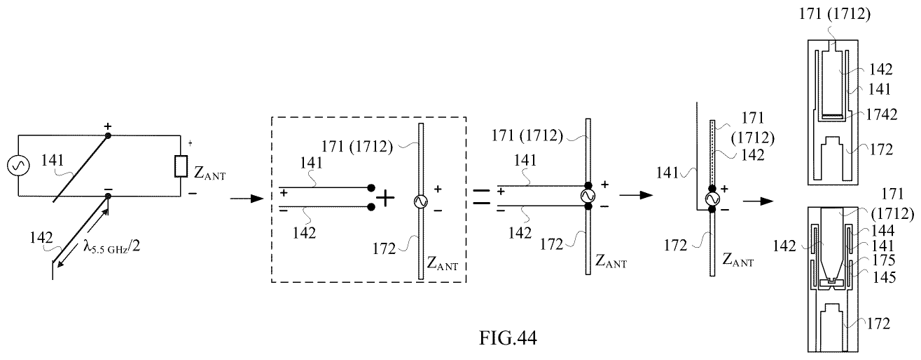

FIG. 44 is a design idea diagram of a high-frequency antenna element 140 in an antenna array according to an embodiment of this application. As shown in FIG. 44, the radiator 171 and the ground plane 172 of the high-frequency antenna element 140 are equivalent to two resistors connected to a positive electrode and a negative electrode of a power source. For example, in the figure, the radiator 171 is connected to the positive electrode, and the ground plane 172 is connected to the negative electrode. One end of the first open-circuit transmission line 141 is connected to the radiating element 1712 close to the ground plane 172, and the other end is open-circuit. One end of the second open-circuit transmission line 142 is connected to the ground plane 172, and the other end is open-circuit.

Then, the first open-circuit transmission line 141 and the second open-circuit transmission line 142 may be integrally designed with the ground plane 172 or the radiating element 1712 close to the ground plane 172. It may be learned from a fourth figure from the left in FIG. 44 that one end of the first open-circuit transmission line 141 may be connected to the ground plane 172, the other end may extend toward the radiating element 1712, and the second open-circuit transmission line 142 may be integrated into the radiating element 1712.

It should be noted that a frequency range suppressed by the high-frequency antenna element 140 in this embodiment of this application is related to the lengths of the first open-circuit transmission line 141 and the second open-circuit transmission line 142. Therefore, the suppressed frequency range may be adjusted by changing the lengths of the first open-circuit transmission line 141 and the second open-circuit transmission line 142. Therefore, specific lengths of the first open-circuit transmission line 141 and the second open-circuit transmission line 142 are not further limited, provided that all technical solutions in which an inter-frequency signal is suppressed by connecting open-circuit transmission lines in parallel fall within the protection scope of embodiments of this application.

In addition, in this embodiment, a position at which the short-circuit transmission line 131 is disposed in the low-frequency antenna element 130 is a symmetric structure, and a position at which the open-circuit transmission line is disposed in the high-frequency antenna element 140 is also a symmetric structure. In this way, pattern performance of the antenna array can be improved.

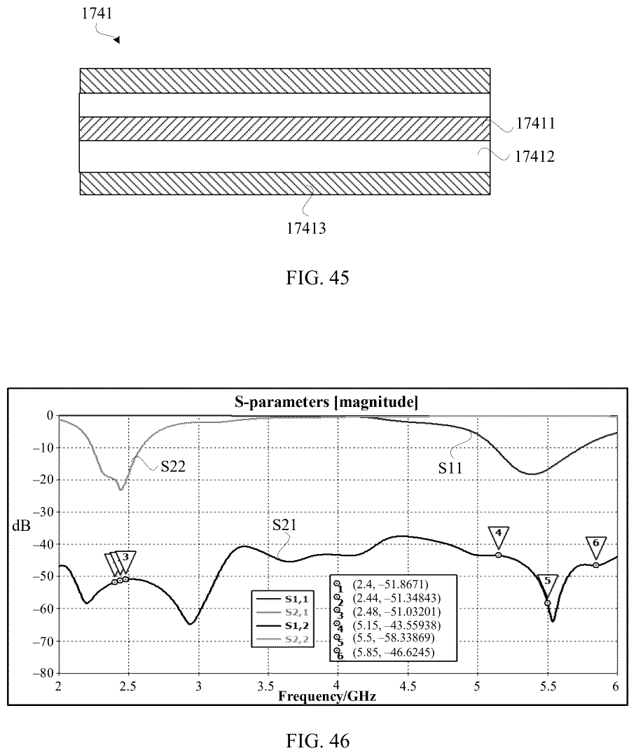

In addition, the feeder 1741 in the feed component 174 in each of the low-frequency antenna element 130 and the high-frequency antenna element 140 may be a coaxial cable. As shown in FIG. 45, the coaxial cable includes a core layer 17411, a dielectric layer 17412, and an outer conductor layer 17413. The core layer 17411 may be connected to the radiating element 1712 close to the ground plane 172, and the outer conductor layer 17413 may be connected to the ground plane 172. For example, the core layer 17411 of the coaxial cable may be connected to a positive electrode of the feed source, and the outer conductor layer 17413 may be connected to a negative electrode of the feed source, so that the feeder 1741 can feed the antenna element.

When the feed source feeds the antenna element through the feeder 1741, there is a partial current on the outer conductor layer 17413. The ground plane 172 is disposed as a U-shaped structure, so that when the feeder 1741 is connected to the ground plane 172, the current on the outer conductor layer 17413 of the feeder 1741 can be transferred to the first sidewall 1722 and the second sidewall 1723 of the U-shaped structure. Because ends that are of the first sidewall 1722 and the second sidewall 1723 and that are away from the top wall 1721 are open, the current on the outer conductor layer 17413 of the feeder 1741 can be released, thereby reducing impact of the current on the outer conductor layer 17413 of the feeder 1741 on radiation of the antenna element.

It should be noted that for both the low-frequency antenna element 130 and the high-frequency antenna element 140, the length of the short-circuit transmission line 131 or the open-circuit transmission line may be changed, so that the low-frequency antenna element 130 and the high-frequency antenna element 140 generate a zero at a required position. Alternatively, a device such as an inductor may be added to the loaded short-circuit transmission line 131 or open-circuit transmission line, to increase an electrical length and reduce a physical length, so as to implement miniaturization development of the low-frequency antenna element 130 or the high-frequency antenna element 140. Certainly, the low-frequency antenna element 130 and the high-frequency antenna element 140 may be further used in another type of dipole antenna or dipole array antenna.

The antenna array is described below.

For ease of description, in this embodiment of this application, a short-circuit transmission line 131 of a low-frequency antenna element 130 is referred to as a filtering structure, and a first open-circuit transmission line 141 and a second open-circuit transmission line 142 of the high-frequency antenna element 140 are also referred to as a filtering structure.

### Scenario 1

The antenna array in this embodiment of this application may be of the structure shown in FIG. 6, a partial structure of the low-frequency antenna element 130 is of the structure shown in FIG. 7, and a partial structure of the high-frequency antenna element 140 is of the structure shown in FIG. 8.

As shown in FIG. 46, S11 is a return loss curve of a 5G antenna (the high-frequency antenna element 140), S22 is a return loss curve of a 2.4G antenna (the low-frequency antenna element 130), and S21 is an isolation curve between the low-frequency antenna element 130 and the high-frequency antenna element 140.

A return loss of the 2.4G antenna in a Wi-Fi 2.4G frequency band is less than −10 dB, and a return loss of the 5G antenna in a Wi-Fi 5G frequency band is less than −7 dB. Isolation between the low-frequency antenna element 130 and the high-frequency antenna element 140 in the 2.4G frequency band is greater than 51 dB, and isolation between the low-frequency antenna element 130 and the high-frequency antenna element 140 in the 5G frequency band is greater than 43 dB.

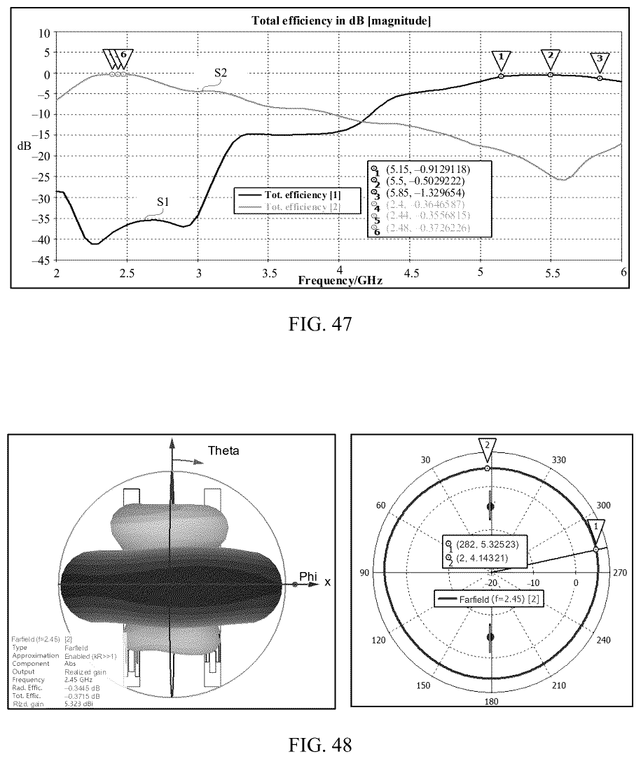

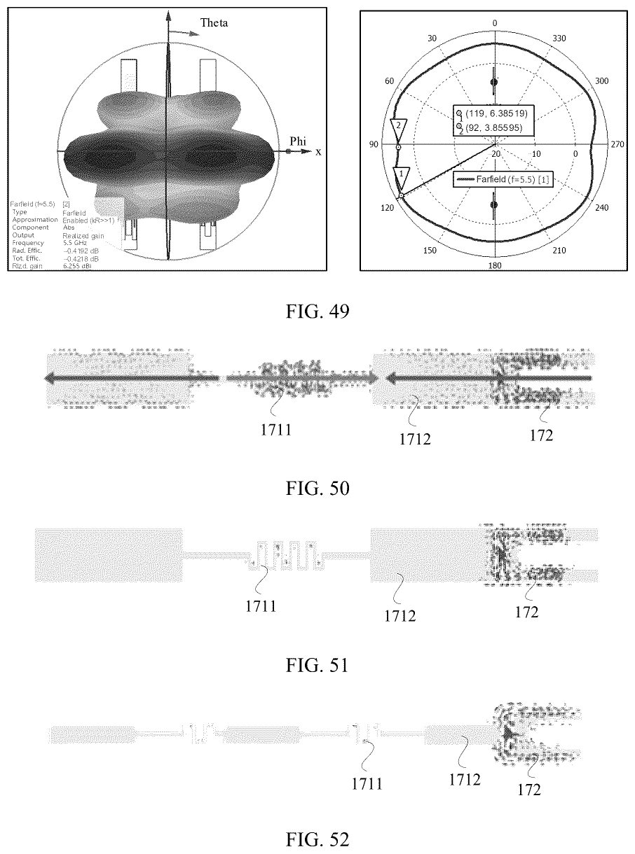

As shown in FIG. 47, S1 is efficiency of the low-frequency antenna element 130, and S2 is efficiency of the high-frequency antenna element 140. The low-frequency antenna element 130 has a zero in a frequency band of the high-frequency antenna element 140, the high-frequency antenna element 140 has a zero in a frequency band of the low-frequency antenna element 130, average in-band efficiency of the 2.4G antenna is approximately −0.4 dB, and average in-band efficiency of the 5G antenna is approximately −0.9 dB. As shown in FIG. 48 and FIG. 49, it may be learned that radiation patterns of the low-frequency antenna element 130 and the high-frequency antenna element 140 are omnidirectional patterns, that is, pattern performance is good.

Table 1 is a table of horizontal plane gains and non-circularity of the low-frequency antenna element 130 and the high-frequency antenna element 140.

TABLE 1

| Antenna performance | 2.4G antenna | 5G antenna |
|---|---|---|
| Antenna efficiency (dB) | −0.4 | −0.9 |
| Antenna gain (dBi) | 5.3 | 6.3 |
| Average horizontal plane gain (dBi) | 4.7 | 4.9 |
| Non-circularity (dB) | 1.2 | 2.5 |
| Isolation (dB) | 51 | 43 |

FIG. 50 is a diagram of current distribution when an operating frequency band of a low-frequency antenna element 130 is in a 2.4G frequency band according to an embodiment of this application. As shown in FIG. 50, when an operating frequency is in the 2.4G frequency band, currents on two radiating elements 1712 of the low-frequency antenna element 130 are in a same direction, and a phase shifter 1711 is at a middle position. The phase shifter 1711 may be configured to adjust phases of the currents on the radiating elements 1712, to generate in-phase currents, thereby achieving a high gain. The current is distributed on an entire radiator 171, and the antenna radiates. FIG. 51 is a diagram of current distribution when an operating frequency band of a low-frequency antenna element 130 is in a 5G frequency band according to an embodiment of this application. As shown in FIG. 51, when an operating frequency is in the 5G frequency band, a current is concentrated in a filtering structure of the low-frequency antenna element 130, and a current on a radiator 171 of the low-frequency antenna element 130 is very weak, and therefore a zero is formed to suppress a harmonic in the 5G frequency band.

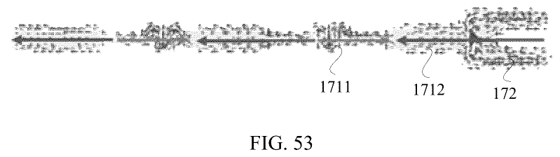

Similarly, for the high-frequency antenna element 140, as shown in FIG. 52 and FIG. 53, in the 2.4G frequency band, a current is confined to a filtering structure of the high-frequency antenna element 140, and therefore a zero is implemented at 2.4G; and in the 5G frequency band, a current is distributed on a radiator 171 of the high-frequency antenna element 140, and the high-frequency antenna element 140 has good radiation performance.

It should be noted that the short-circuit transmission line 131 may be disposed by cutting a groove on a ground plane 172, and the open-circuit transmission line may be disposed by loading a transmission line. According to the low-frequency antenna element 130 and the high-frequency antenna element 140 provided in this embodiment of this application, the ground plane 172 and the filtering structure are integrally designed by cutting a groove on the ground plane 172 or loading a transmission line. Compared with a conventional external series-fed dipole array antenna, in this embodiment of this application, the isolation is improved by 21 dB in the 2.4G frequency band, and the isolation is improved by approximately 19 dB in the 5G frequency band. In addition, this disclosure provides a single-sided board filtering antenna solution with a simple structure and low costs.

Compared with a technical solution in which interference between inter-frequency antennas is resolved by using a cascaded filter in the related technology, in this application, the filtering structure is integrally designed with a structure of the antenna element by changing only a structure of the ground plane 172 or the radiator 171, and a filtering effect can be introduced without using a cascaded filter or integrating a microstrip filter structure into an antenna feeder 1741. In addition, it can be ensured that an antenna size is not increased, and antenna radiation is omnidirectional, thereby significantly improving isolation between inter-frequency antennas.

### Scenario 2

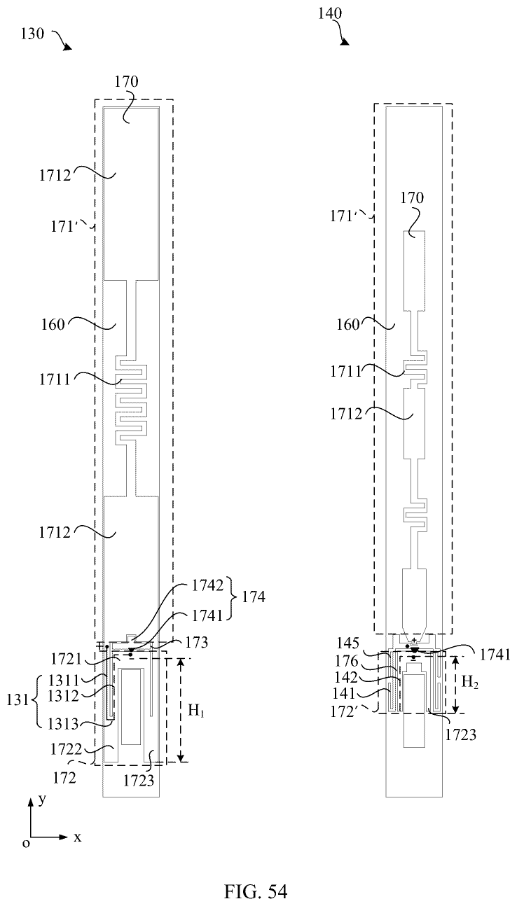

Certainly, in another embodiment, the low-frequency antenna element 130 and the high-frequency antenna element 140 in the antenna array may alternatively be in other forms. As shown in FIG. 54, in this embodiment, the low-frequency antenna element 130 is of the structure shown in FIG. 7, and the high-frequency antenna element 140 is of the structure shown in FIG. 33. A radiator 171 of the high-frequency antenna element 140 includes three radiating elements 1712 and two phase shifters 1711, to further suppress a low-frequency signal at 2.4G and improve isolation between antennas at 2.4G.

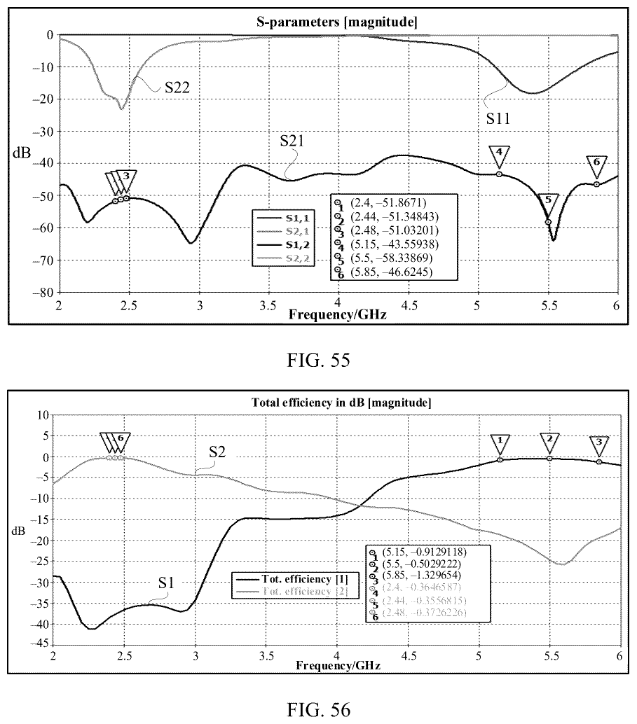

FIG. 55 shows an S-parameter of an antenna array. As shown in FIG. 55, S11 is a return loss curve of a 5G antenna (the high-frequency antenna element 140), S22 is a return loss curve of a 2.4G antenna (the low-frequency antenna element 130), and S21 is an isolation curve between the low-frequency antenna element 130 and the high-frequency antenna element 140. A return loss of the 2.4G antenna in a Wi-Fi 2.4G frequency band is less than −10 dB, and a return loss of the 5G antenna in a Wi-Fi 5G frequency band is less than −10 dB. Isolation between the low-frequency antenna element 130 and the high-frequency antenna element 140 in the 2.4G frequency band is greater than 67 dB, and isolation between the low-frequency antenna element 130 and the high-frequency antenna element 140 in the 5G frequency band is greater than 42.5 dB.

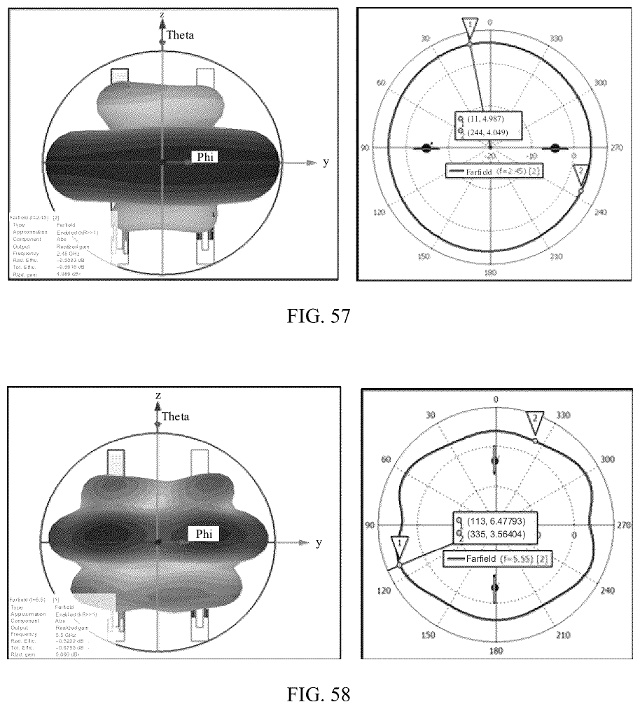

As shown in FIG. 56, S1 is efficiency of the low-frequency antenna element 130, and S2 is efficiency of the high-frequency antenna element 140. The high-frequency antenna element 140 has a zero in a frequency band of the low-frequency antenna element 130, the low-frequency antenna element 130 has a zero in a frequency band of the high-frequency antenna element 140, average in-band efficiency of the 2.4G antenna is approximately −0.6 dB, and average in-band efficiency of the 5G antenna is approximately −0.7 dB. As shown in FIG. 57 and FIG. 58, it may be learned that radiation patterns of the low-frequency antenna element 130 and the high-frequency antenna element 140 are omnidirectional patterns, that is, pattern performance is good.

Table 2 is a table of horizontal plane gains and non-circularity of the low-frequency antenna element 130 and the high-frequency antenna element 140.

TABLE 2

| Antenna performance | 2.4G antenna | 5G antenna |
|---|---|---|
| Antenna efficiency (dB) | −0.6 | −0.7 |
| Antenna gain (dBi) | 5 | 5.7 |
| Average horizontal plane gain (dBi) | 4.4 | 4 |
| Non-circularity (dB) | 0.9 | 3 |
| Isolation (dB) | 67 | 42.5 |

For a diagram of current distribution on the low-frequency antenna element 130, refer to FIG. 50 and FIG. 51. As shown in FIG. 50, when an operating frequency is in the 2.4G frequency band, currents on two radiating elements 1712 of the low-frequency antenna element 130 are in a same direction, and a phase shifter 1711 is at a middle position. The phase shifter 1711 may be configured to adjust phases of the currents on the radiating elements 1712, to generate in-phase currents, thereby achieving a high gain. As shown in FIG. 51, when an operating frequency is in the 5G frequency band, a current is concentrated in a filtering structure of the low-frequency antenna element 130, and a current on a radiator 171 of the low-frequency antenna element 130 is very weak, and therefore a zero is formed to suppress a harmonic in the 5G frequency band.

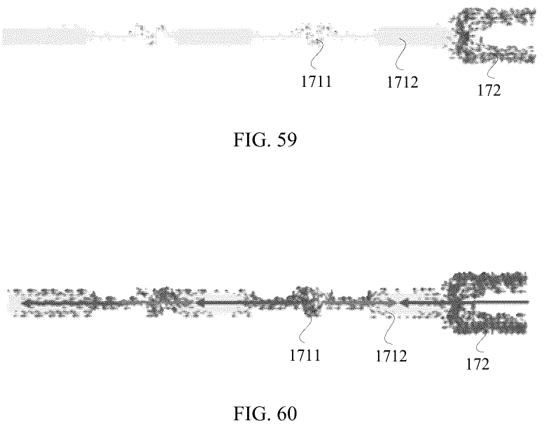

Similarly, for the high-frequency antenna element 140, FIG. 59 is a diagram of current distribution when an operating frequency band of a high-frequency antenna element is in a 2.4G frequency band according to an embodiment of this application. As shown in FIG. 59, a current is concentrated in a filtering structure of the high-frequency antenna element 140, and a current on the radiator 171 of the high-frequency antenna element 140 is very weak, and therefore a zero is formed to suppress a signal in the 2.4G frequency band. FIG. 60 is a diagram of current distribution when an operating frequency band of a high-frequency antenna element is in a 5G frequency band according to an embodiment of this application. As shown in FIG. 60, three radiating elements 1712 are disposed on the high-frequency antenna element 140, a current is distributed on the entire radiator 171, and the high-frequency antenna element 140 has good radiation performance.

Compared with the embodiment shown in FIG. 7, in the embodiment shown in FIG. 54, the first open-circuit transmission line 141 of the high-frequency antenna element 140 has a longer length and is disposed in a folded manner, to better suppress a signal in the 2.4G frequency band. In addition, an L-shaped matching stub 145 and slot coupled feeding are loaded, to improve impedance bandwidth of the Wi-Fi 5G antenna. Compared with a series-fed dipole array antenna in the related technology, in this embodiment of this application, the isolation in the 2.4G frequency band is improved by approximately 37 dB, the isolation in the 5G frequency band is expected to be improved by approximately 18.5 dB, and a gain is significant.

### Scenario 3

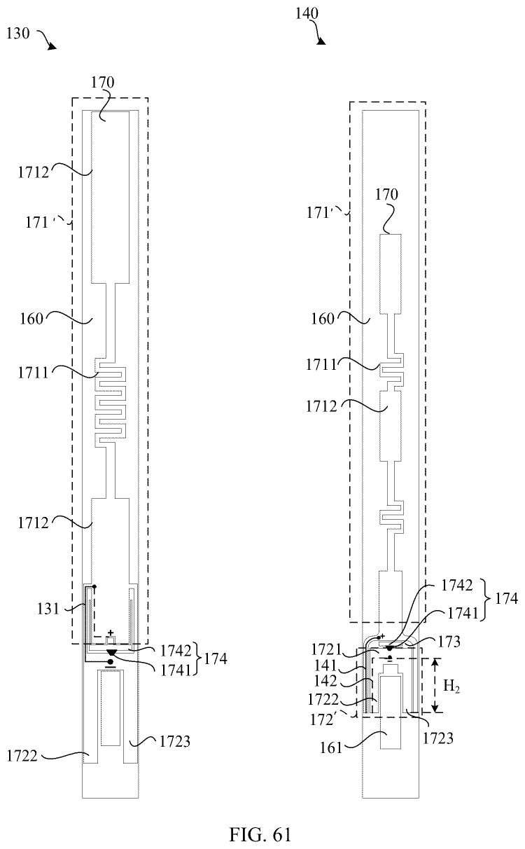

In some other embodiments, the low-frequency antenna element 130 and the high-frequency antenna element 140 in the antenna array may alternatively be in other forms. As shown in FIG. 61, in this embodiment, the low-frequency antenna element 130 is of the structure shown in FIG. 16, and the high-frequency antenna element 140 is of the structure shown in FIG. 8.

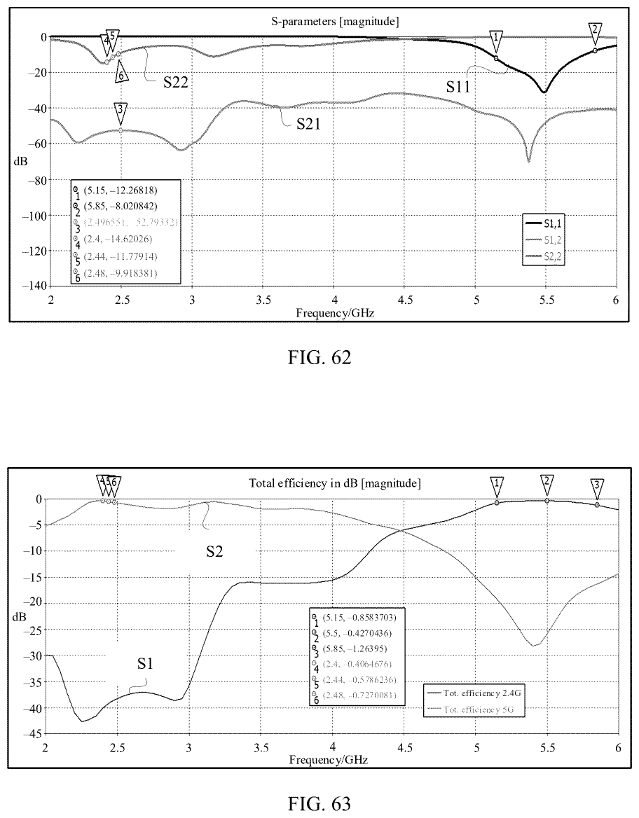

FIG. 62 shows an S-parameter of an antenna array. As shown in FIG. 62, S11 is a return loss curve of a 5G antenna (the high-frequency antenna element 140), S22 is a return loss curve of a 2.4G antenna (the low-frequency antenna element 130), and S21 is an isolation curve between the low-frequency antenna element 130 and the high-frequency antenna element 140. A return loss of the 2.4G antenna in a Wi-Fi 2.4G frequency band is less than −10 dB, and a return loss of the 5G antenna in a Wi-Fi 5G frequency band is less than −10 dB. Isolation between the low-frequency antenna element 130 and the high-frequency antenna element 140 in the 2.4G frequency band is greater than 53 dB, and isolation between the low-frequency antenna element 130 and the high-frequency antenna element 140 in the 5G frequency band is greater than 41 dB.

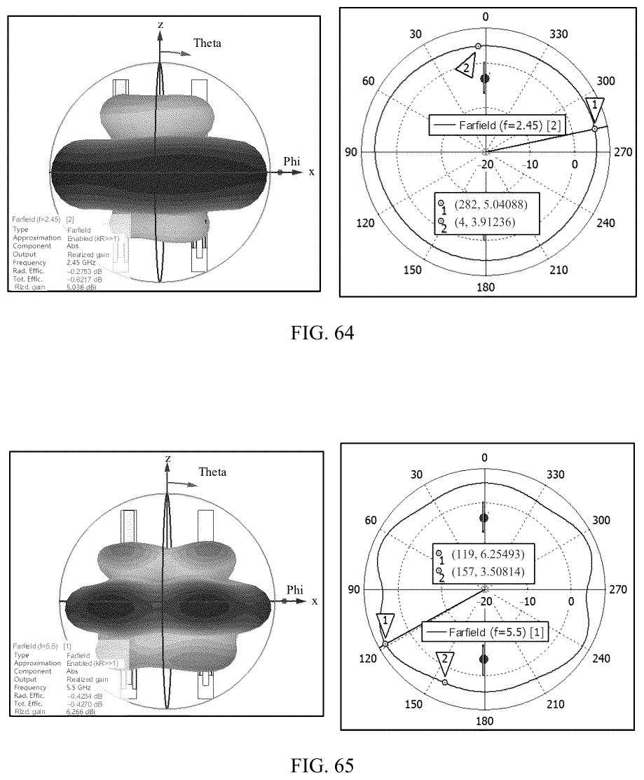

As shown in FIG. 63, S1 is efficiency of the low-frequency antenna element 130, and S2 is efficiency of the high-frequency antenna element 140. The high-frequency antenna element 140 has a zero in a frequency band of the low-frequency antenna element 130, the low-frequency antenna element 130 has a zero in a frequency band of the high-frequency antenna element 140, average in-band efficiency of the 2.4G antenna is −0.6 dB, and average in-band efficiency of the 5G antenna is −0.8 dB. As shown in FIG. 64 and FIG. 65, it may be learned that antenna radiation is an omnidirectional pattern.

Table 3 is a table of horizontal plane gains and non-circularity of the low-frequency antenna element 130 and the high-frequency antenna element 140.

TABLE 3

| Antenna performance | 2.4G antenna | 5G antenna |
|---|---|---|
| Antenna efficiency (dB) | −0.6 | −0.8 |
| Antenna gain (dBi) | 5 | 6.3 |
| Average horizontal plane gain (dBi) | 4.4 | 4.7 |
| Non-circularity (dB) | 1 | 2.8 |
| Isolation (dB) | 53 | 41 |

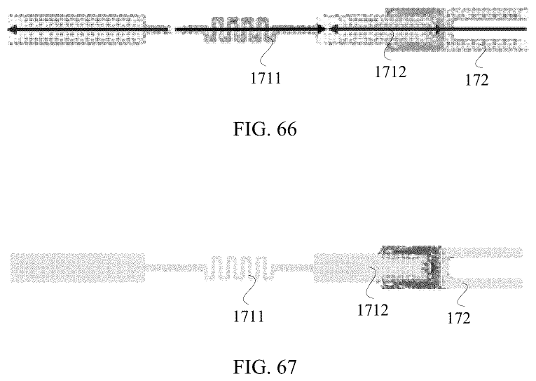

FIG. 66 is a diagram of current distribution when an operating frequency band of a low-frequency antenna element 130 is in a 2.4G frequency band according to an embodiment of this application. As shown in FIG. 66, when an operating frequency is in the 2.4G frequency band, a current is distributed on an entire radiator 171, and the antenna radiates. FIG. 67 is a diagram of current distribution when an operating frequency band of a low-frequency antenna element 130 is in a 5G frequency band according to an embodiment of this application. As shown in FIG. 67, when an operating frequency is in the 5G frequency band, a current is concentrated in a filtering structure of the low-frequency antenna element 130, that is, the current is concentrated in a partial structure in which the short-circuit transmission line 131 is disposed in the low-frequency antenna element 130, and a current on a radiator 171 of the low-frequency antenna element 130 is very weak, and therefore a zero is formed to suppress a harmonic in the 5G frequency band.

Similarly, for the high-frequency antenna element 140, as shown in FIG. 52 and FIG. 53, in the 2.4G frequency band, a current is confined to a filtering structure of the high-frequency antenna element 140, and therefore a zero is implemented at 2.4G; and in the 5G frequency band, a current is distributed on a radiator 171 of the high-frequency antenna element 140, and the high-frequency antenna element 140 has good radiation performance.

Compared with the antenna arrays in the scenario 1 and the scenario 2, in the antenna array in this embodiment of this application, according to the low-frequency antenna element 130 (the Wi-Fi 2.4G antenna), the filtering structure and the antenna radiator 171 are integrally designed by cutting a groove on a radiating element 1712, so that a structure of a ground plane 172 is more complete, and non-circularity of the pattern is slightly better. Compared with a series-fed dipole array antenna in the related technology, in this embodiment of this application, the isolation in the 2.4G frequency band is improved by approximately 23 dB, the isolation in the 5G frequency band is expected to be improved by approximately 16.5 dB, and a gain is significant.

It should be noted that in another embodiment, low-frequency antenna elements 130 and high-frequency antenna elements 140 of different structures may be designed in combination. For example, the low-frequency antenna element 130 in the antenna array may be of the structure in FIG. 16, and the high-frequency antenna element 140 is of the structure shown in FIG. 33. The structures of the low-frequency antenna element 130 and the high-frequency antenna element 140 in the antenna array are not further limited.

In the antenna array provided in this embodiment of this application, the low-frequency antenna element 130 and the high-frequency antenna element 140 that have a filtering function are disposed, so that isolation between inter-frequency antennas can be improved when the low-frequency antenna element and the high-frequency antenna element are used as inter-frequency antenna elements. In addition, because the filtering structure of each of the low-frequency antenna element 130 and the high-frequency antenna element 140 is integrated into a metal layer 170, there is no need to increase a volume of the antenna element, thereby facilitating miniaturization development of the antenna array.

In addition, an embodiment of this application further provides a terminal device 30, including the antenna array provided in the third aspect. The terminal device 30 is not limited to a mobile or fixed terminal having a communication function, for example, a router 20, a mobile phone, a tablet computer, a notebook computer, an ultra-mobile personal computer (UMPC), a handheld computer, an intercom, a netbook, a personal digital assistant (PDA), an event data recorder, a wearable device, or a virtual reality device.

According to the terminal device 30 provided in this embodiment of this application, the antenna array provided in the third aspect is disposed, so that assembly space reserved in the terminal device 30 for mounting the antenna array can be reduced, thereby facilitating miniaturization development of the terminal device 30.

It should be understood that in this application, “electrical connection” may be understood as physical contact and electrical conduction between components, or may be a coupled connection; or may be understood as a form in which different components in a line structure are connected through a physical line that can transmit an electrical signal, for example, a printed circuit board (PCB) copper foil or a conducting wire. “Coupling” may be understood as electrical conduction implemented through air in an indirect coupling manner. The coupling in this application may be understood as capacitive coupling. For example, an equivalent capacitor is formed through coupling between gaps separating two conductive members, to implement signal transmission. A person skilled in the art may understand that a coupling phenomenon is a phenomenon that inputs and outputs of two or more circuit elements or electrical networks closely cooperate with each other and affect each other, and energy is transmitted from one side to the other side through interaction. “Communication connection” may mean electrical signal transmission, including a wireless communication connection and a wired communication connection. The wireless communication connection does not require a physical medium and is not a connection relationship that limits a product structure. Both “connection” and “interconnection” may mean a mechanical connection relationship or a physical connection relationship. That is, a connection between A and B or an interconnection between A and B may mean that there is a fastener (for example, a screw, a bolt, or a rivet) between A and B, or A and B are in contact with each other and A and B are difficult to be separated. Opposite/Disposed opposite to each other: A and B being disposed opposite to each other may mean that A and B are disposed face to face (e.g., facing toward each other).

In the descriptions of embodiments of this application, it should be noted that unless otherwise clearly specified and limited, the terms “mounting”, “interconnection”, and “connection” should be understood in a broad sense. For example, there may be a fixed connection, may be an indirect connection through an intermediate medium, or may be an internal connection between two elements or an interaction relationship between two elements. A person of ordinary skill in the art may understand specific meanings of the foregoing terms in embodiments of this application based on a specific situation.

In the specification, claims, and accompanying drawings of embodiments of this application, the terms “first”, “second”, “third”, “fourth”, and the like (if present) are used to distinguish between similar objects, and are not necessarily used to describe a specific sequence or order.

What is claimed is:

1. A low-frequency antenna element, comprising:
a metal layer located on a surface of a substrate, the metal layer comprising a ground plane, a radiator, and a short-circuit transmission line, wherein:
a first slot is disposed between the ground plane and the radiator, the first slot extends in a first direction,
the ground plane and the radiator are respectively on two sides of the first slot in a second direction, and
the first direction is perpendicular to the second direction; and
a feed component disposed in the first slot, the feed component including a positive electrode of the feed component and a negative electrode of the feed component, wherein:
the radiator is connected to the positive electrode of the feed component, and a positive electrode of the low-frequency antenna element is located on the radiator, and
the ground plane is further connected to the negative electrode of the feed component, and a negative electrode of the low-frequency antenna element is located on the ground plane, wherein:
one end of the short-circuit transmission line is connected to the positive electrode of the low-frequency antenna element, and
an opposing end of the short-circuit transmission line is connected to the negative electrode of the low-frequency antenna element, and
at least a partial structure of the short-circuit transmission line is located on the ground plane or the radiator; and
wherein the second direction is an extension direction of the metal layer.

2. The low-frequency antenna element according to claim 1, wherein a length from the positive electrode of the low-frequency antenna element to the negative electrode of the low-frequency antenna element along an extension path of the short-circuit transmission line is a wavelength corresponding to a center frequency in a suppressed frequency band of the low-frequency antenna element.

3. The low-frequency antenna element according to claim 1, wherein the short-circuit transmission line comprises a first extension section, a second extension section, and a connection section;
at least a part of the first extension section and a partial structure of the second extension section are disposed opposite to each other, there is a second slot between the first extension section extending in the second direction and the second extension section extending in the second direction, and one end of the second slot communicates with the first slot; and
the connection section is located at an end that is of the second slot and that is away from the first slot, one end of the connection section is connected to the first extension section, and the other end is connected to the second extension section.

4. The low-frequency antenna element according to claim 3, wherein the first extension section is of an L-shaped structure, a part of the first extension section extends in the first direction, and a part of the first extension section extends in the second direction;
the second extension section is of an L-shaped structure, a part of the second extension section extends in the first direction, and a part of the second extension section extends in the second direction; and
a part of the first slot is formed between the part that is of the first extension section and that extends in the first direction and the part that is of the second extension section and that extends in the first direction.

5. The low-frequency antenna element according to claim 4, wherein in the first direction, the second extension section is closer to a center position of the metal layer than the first extension section;
the short-circuit transmission line is a partial structure of the radiator, the first extension section is connected to the negative electrode of the low-frequency antenna element, and the second extension section is connected to the positive electrode of the low-frequency antenna element; and
the first extension section extending in the first direction is a partial structure of the ground plane, and the second extension section extending in the first direction is a partial structure of the radiator.

6. The low-frequency antenna element according to claim 5, wherein a part of the second extension section extending in the second direction is disposed at an interval from the radiator; or
the second extension section extending in the second direction is a partial structure of the radiator.

7. The low-frequency antenna element according to claim 1, wherein the feed component comprises a feeder; and
a positive electrode of the feeder is connected to the radiator, and a negative electrode of the feeder is connected to the ground plane.

8. The low-frequency antenna element according to claim 1, wherein the ground plane is of a U-shaped structure;
the U-shaped structure comprises a top wall, a first sidewall, and a second sidewall, the first sidewall and the second sidewall are disposed opposite to each other, and the first sidewall and the second sidewall are respectively located at two ends of the top wall; and
an opening of the U-shaped structure faces a surface that is of the ground plane and that is away from the radiator, and the top wall is located at an end that is of the ground plane and that is close to the radiator.

9. A high-frequency antenna element, comprising:
a metal layer including a ground plane, a radiator, and open-circuit transmission lines, wherein:
a first slot is disposed between the ground plane and the radiator, the first slot extending in a first direction,
the ground plane and the radiator are respectively at two ends of the first slot in a second direction being an extension direction of the metal layer, and
the first direction is perpendicular to the second direction; and
a feed component disposed in the first slot, the feed component including a positive electrode of the feed component and a negative electrode of the feed component, wherein:
the radiator is connected to a positive electrode of the feed component,
a positive electrode of the high-frequency antenna element is located on the radiator,
the ground plane is connected to a negative electrode of the feed component, and
a negative electrode of the high-frequency antenna element is located on the ground plane, and wherein:
the open-circuit transmission lines comprise:
a first open-circuit transmission line, and
a second open-circuit transmission line disposed at an interval from the first open-circuit transmission line;
one end of the first open-circuit transmission line is connected to one of the positive electrode or the negative electrode of the high-frequency antenna element, and
an opposing end of the first open-circuit transmission line is open-circuit;
one end of the second open-circuit transmission line is connected to the other one of the positive electrode or the negative electrode of the high-frequency antenna element, and
an opposing end of the first open-circuit transmission line is open-circuit.

10. The high-frequency antenna element according to claim 9, wherein a sum of an extension length of the first open-circuit transmission line and an extension length of the second open-circuit transmission line is less than or equal to a wavelength corresponding to a resonance frequency of the high-frequency antenna element.

11. The high-frequency antenna element according to claim 9, wherein the first open-circuit transmission line is located on an outer side of the second open-circuit transmission line, and the second open-circuit transmission line is a partial structure of the ground plane or the radiator.

12. The high-frequency antenna element according to claim 11, wherein the first open-circuit transmission line comprises an extension portion;
the extension portion is of an L-shaped structure, a part of the extension portion extends in the first direction, and a part of the extension portion extends in the second direction; and
the extension portion is disposed on a side that is of the first open-circuit transmission line and that is away from a center position of the ground plane, a free end of the extension portion extending in the first direction is connected to an end that is of the first open-circuit transmission line and that is away from the first slot, and the part that is of the extension portion and that extends in the second direction and a part that is of the first open-circuit transmission line and that is opposite to the second open-circuit transmission line are disposed at an interval.

13. The high-frequency antenna element according to claim 12, wherein the first open-circuit transmission line further comprises a matching stub; and
the matching stub is an L-shaped matching stub, one end of the L-shaped matching stub is connected to the first open-circuit transmission line, and the other end extends in the second direction toward the extension portion.

14. A terminal device, comprising at least one of:
a low-frequency antenna element, wherein the low-frequency antenna element comprises a metal layer and a substrate, wherein the metal layer is located on a surface of the substrate, and the metal layer comprises a ground plane, a radiator, and a short-circuit transmission line; a first slot is disposed between the ground plane and the radiator, the first slot extends in a first direction, the ground plane and the radiator are respectively on two sides of the first slot in a second direction, and the first direction is perpendicular to the second direction; a feed component is disposed in the first slot, the radiator is connected to a positive electrode of the feed component, and a positive electrode of the low-frequency antenna element is located on the radiator; the ground plane is connected to a negative electrode of the feed component, and a negative electrode of the low-frequency antenna element is located on the ground plane; one end of the short-circuit transmission line is connected to the positive electrode of the low-frequency antenna element, the other end is connected to the negative electrode of the low-frequency antenna element, and at least a partial structure of the short-circuit transmission line is located on the ground plane or the radiator; and the second direction is an extension direction of the metal layer; or
a high-frequency antenna element, wherein the high-frequency antenna element comprises a metal layer, wherein the metal layer comprises a ground plane, a radiator, and open-circuit transmission lines; a first slot is disposed between the ground plane and the radiator, the first slot extends in a first direction, the ground plane and the radiator are respectively at two ends of the first slot in a second direction, and the first direction is perpendicular to the second direction; a feed component is disposed in the first slot, the radiator is connected to a positive electrode of the feed component, a positive electrode of the high-frequency antenna element is located on the radiator, the ground plane is connected to a negative electrode of the feed component, and a negative electrode of the high-frequency antenna element is located on the ground plane; the open-circuit transmission lines comprise a first open-circuit transmission line and a second open-circuit transmission line, and the first open-circuit transmission line and the second open-circuit transmission line are disposed at an interval; one end of the first open-circuit transmission line is connected to one of the positive electrode or the negative electrode of the high-frequency antenna element, and the other end is open-circuit; one end of the second open-circuit transmission line is connected to the other one of the positive electrode or the negative electrode of the high-frequency antenna element, and the other end is open-circuit; and the second direction is an extension direction of the metal layer.

15. The terminal device according to claim 14, wherein, terminal device comprises the low-frequency antenna element and the high-frequency antenna element, wherein the low-frequency antenna element and the high-frequency antenna element are alternately disposed at an interval.

16. The terminal device according to claim 14, wherein a length from the positive electrode of the low-frequency antenna element to the negative electrode of the low-frequency antenna element along an extension path of the short-circuit transmission line is a wavelength corresponding to a center frequency in a suppressed frequency band of the low-frequency antenna element.

17. The terminal device according to claim 16, wherein a resonance frequency of the low-frequency antenna element is 2.45 GHz, and the suppressed frequency band of the low-frequency antenna element is 5.15 GHz to 5.85 GHz.

18. The terminal device according to claim 14, wherein the short-circuit transmission line comprises a first extension section, a second extension section, and a connection section;
at least a part of the first extension section and a partial structure of the second extension section are disposed opposite to each other, there is a second slot between the first extension section extending in the second direction and the second extension section extending in the second direction, and one end of the second slot communicates with the first slot; and
the connection section is located at an end that is of the second slot and that is away from the first slot, one end of the connection section is connected to the first extension section, and the other end is connected to the second extension section.

19. The terminal device according to claim 14, wherein a resonance frequency of the high-frequency antenna element is 5.5 GHz, and a suppressed frequency band of the high-frequency antenna element is 2.4 GHz to 2.48 GHz.

20. The terminal device according to claim 14, wherein a sum of an extension length of the first open-circuit transmission line and an extension length of the second open-circuit transmission line is less than or equal to a wavelength corresponding to a resonance frequency of the high-frequency antenna element.
